(19) United States
(12) Patent Application Publication
(10) Pub. No.: US 2018/0289451 A1
(43) Pub. Date: Oct. 11, 2018

(54) ORTHDONTIC BRACKET

(71) Applicant: Grin Co., Ltd., Tokyo (JP)

(72) Inventor: Sadahiro Hayashi, Tokyo (JP)

(21) Appl. No.: 16/004,427

(22) Filed: Jun. 11, 2018

Related U.S. Application Data
(63) Continuation of application No. PCT/JP2016/087992, filed on Dec. 20, 2016.

(30) Foreign Application Priority Data
Dec. 20, 2015 (JP) 2015-248088

(51) Int. Cl. A61C 7/28; A61C 7/14; A61C 7/30

(52) U.S. Cl. CPC A61C 7/28; A61C 7/303; A61C 7/141

(57) ABSTRACT

An orthodontic bracket is used for correcting the dentition of a patient. The orthodontic bracket includes a wire holder having a wire hole (through-hole) through which an arch wire for orthodontic treatment is inserted, and a bracket base that detachably supports the wire holder and is affixed to a tooth surface of the patient.

### CROSS-REFERENCE TO RELATED APPLICATIONS

This application is a continuation application of International Patent Application No. PCT/JP2016/087992 filed on Dec. 20, 2016, which is based upon and claims the benefit of priority from the prior Japanese Patent Application No. 2015-248088, filed Dec. 20, 2015, the entire contents of which are incorporated herein by reference.

### TECHNICAL FIELD

The present invention relates to an orthodontic bracket which is used for correcting misaligned teeth or twisted teeth.

### BACKGROUND ART

In general, orthodontic brackets are used for orthodontic treatment. An orthodontic bracket is attached to the teeth of a patient who is to receive orthodontic treatment. A wire slot. for mounting an arch wire for generating an orthodontic force is provided in the bracket. The arch wire is fitted into the wire slot in the bracket, and is fixed to the orthodontic bracket by being ligated using a ligature tool such as a ligature ring or a rubber piece.

On the other hand, a type of orthodontic bracket referred to as a “self-ligating bracket” that requires no ligating work is known. In the case of using a self-ligating bracket, for example, an arch wire can be fixed in a wire slot by sliding an approximately U-shaped lock member (Patent Literature 1), or a shutter made of elastic stainless steel can be rotated to fix an arch wire inside a wire slot (Patent Literature 2).

Thus, in the case of using a self-ligating bracket, because an arch wire can be mounted to or detached from a bracket by a simple operation that involves moving or rotating a lock member or a shutter, the treatment time can be shortened.

### CITATION LIST

### Patent Literature

### [Patent Literature 1]

Japanese Patent No. 4444410

### [Patent Literature 2]

National Publication of International Patent. Application No. 2001-503305

### SUMMARY OF INVENTION

### Technical Problem

In the aforementioned self-ligating brackets, the internal dimensions of a wire slot into which an arch wire is inserted are fixed. On the other hand, arch wires have various external dimensions. Accordingly, in some cases a gap arises between a wire slot and an arch wire, and furthermore, the gap varies depending on the thickness of the arch wire that is selected. A gap between a wire slot and an arch wire causes a loss in the wire torque, thus lowering the orthodontic force.

An object of the present invention is to provide a bracket that improves workability when mounting an arch wire to the surface of a tooth of a patient, and also enables mounting of arch wires of various thicknesses while suppressing a loss in torque.

### Solution to Problem

An orthodontic bracket according to the present embodiment is used for correcting dentition of a patient, the orthodontic bracket including: a wire holder having at least one through-hole through which an arch wire for orthodontic treatment is to be inserted; and a bracket base which detachably supports the wire holder, and which is to be affixed to a surface of a tooth of the patient.

### Advantageous Effects of Invention

According to the orthodontic bracket of the present invention, an operation for mounting an arch wire to the teeth of a patient is performed by first affixing bracket bases to the surface of the teeth of the patient, and thereafter mounting a wire holder in each of the bracket bases. By inserting an arch wire into a through-hole of each wire holder in advance, the operation for mounting the arch wire is completed by merely fitting the wire holders into the bracket bases. It will be understood that the workability is thereby improved in comparison to a case where brackets are affixed to the surface of teeth of a patient and a long arch wire is then mounted in the brackets. A loss of torque of an arch wire can be suppressed by selectively using in an appropriate manner wire holders that have a through-hole that conforms to the shape and external dimensions of the arch wire. Further, it is possible to correspond to the use of arch wires of various dimensions by using wire holders that have through-holes of various sizes in an appropriate manner according to the dimensions of the relevant arch wire. Thus, the designed torque can be transferred to the surface of the teeth of the patient.

### BRIEF DESCRIPTION OF DRAWINGS

FIG. 1 is a perspective view illustrating the outer appearance of an orthodontic bracket having a basic configuration according to one embodiment of the present invention.

FIG. 2 is a perspective view illustrating the outer appearance of a wire holder and a bracket base constituting the orthodontic bracket illustrated in FIG. 1.

FIG. 3 is a front view of the orthodontic bracket illustrated in FIG. 1.

FIG. 4 is a bottom view of the orthodontic bracket illustrated in FIG. 1.

FIG. 5 is a bottom view of the orthodontic bracket illustrated in FIG. 1.

FIG. 6 is a side view of a wire holder.

FIG. 7 is a cross-sectional view along a section line A-A in FIG. 3 of the wire holder.

FIG. 8 is a front view of the surface of the wire holder.

FIG. 9 is a side view of an upper part of the wire holder.

FIG. 10 is a side view of a lower part of the wire holder.

FIG. 11 is a side view of a rightward part of the wire holder.

FIG. 12 is a cross-sectional view of the wire holder along a section line B-B shown in FIG. 8.

FIG. 13 is a perspective view illustrating the outer appearance of a holder fixing pin.

FIG. 14 is a cross-sectional view along the section line A-A shown in FIG. 3 that illustrates the state of the holder fixing pin when mounting the wire holder in a holder slot.

FIG. 15 is a perspective view illustrating the outer appearance of a wire holder and a bracket base constituting an orthodontic bracket according to a first modification.

FIG. 16 is a perspective view illustrating the outer appearance of the orthodontic bracket illustrated in FIG. 15.

FIG. 17 is a cross-sectional view of the orthodontic bracket along a section line C-C in FIG. 16.

FIG. 18 is a perspective view illustrating the outer appearance of a wire holder and a bracket base constituting an orthodontic bracket according to a second modification.

FIG. 19 is a perspective view illustrating the outer appearance of the orthodontic bracket illustrated in FIG. 18.

FIG. 20 is a cross-sectional view of the orthodontic bracket along a section line D-D in FIG. 19.

FIG. 21 is a perspective view illustrating the outer appearance of a wire holder and a bracket base constituting an orthodontic bracket according to a third modification.

FIG. 22 is a perspective view illustrating the outer appearance of the orthodontic bracket illustrated in FIG. 21.

FIG. 23 is a cross-sectional view of the orthodontic bracket along a section line J-J in FIG. 22.

FIG. 24 is a perspective view illustrating the outer appearance of a wire holder, a bracket base and a clip constituting an orthodontic bracket according to a fourth modification.

FIG. 25 is a perspective view illustrating the outer appearance of the orthodontic bracket illustrated in FIG. 24.

FIG. 26 is a side view of the orthodontic bracket illustrated in FIG. 25.

FIG. 27 is a front view of the orthodontic bracket illustrated in FIG. 25.

FIG. 28 is a perspective view illustrating the outer appearance of a wire holder and a bracket base constituting an orthodontic bracket according to a fifth modification.

FIG. 29 is a perspective view illustrating the outer appearance of the orthodontic bracket illustrated in FIG. 28.

FIG. 30 is a perspective view illustrating the outer appearance of a wire holder and a bracket base constituting an orthodontic bracket according to a sixth modification.

FIG. 31 is a perspective view illustrating the outer appearance of the orthodontic bracket illustrated in FIG. 30.

FIG. 32 is a cross-sectional view of the orthodontic bracket along a section line L-L in FIG. 31.

FIG. 33 is a perspective view illustrating the outer appearance of a wire holder pair obtained by coupling together, with a rubber piece, wire holders that are included in an orthodontic bracket according to a seventh modification.

FIG. 34 is a perspective view illustrating the outer appearance of an orthodontic bracket in which the wire holder pair shown in FIG. 33 is mounted on a bracket base.

FIG. 35 is a cross-sectional view of the orthodontic bracket along a section line M-M in FIG. 34.

FIG. 36 is a perspective view illustrating the outer appearance of a wire holder and a bracket base constituting an orthodontic bracket according to the seventh modification.

FIG. 37 is a perspective view illustrating the outer appearance of the orthodontic bracket illustrated in FIG. 36.

FIG. 38 is a cross-sectional view of the orthodontic bracket along a section line Q-Q in FIG. 37.

FIG. 39 is another cross-sectional view of the orthodontic bracket along the section line Q-Q in FIG. 37.

### DESCRIPTION OF EMBODIMENTS

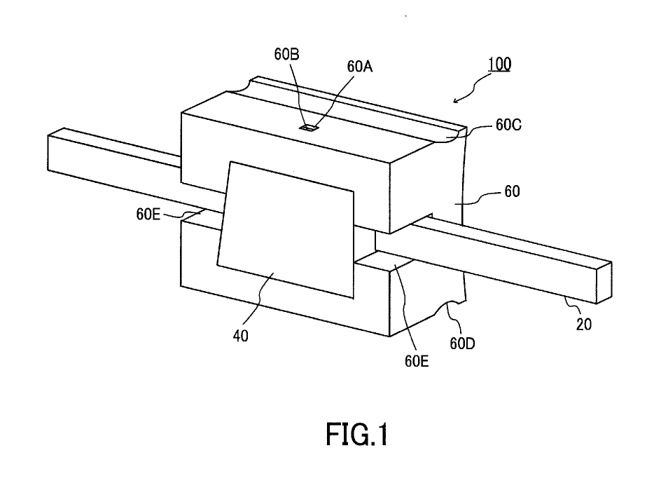

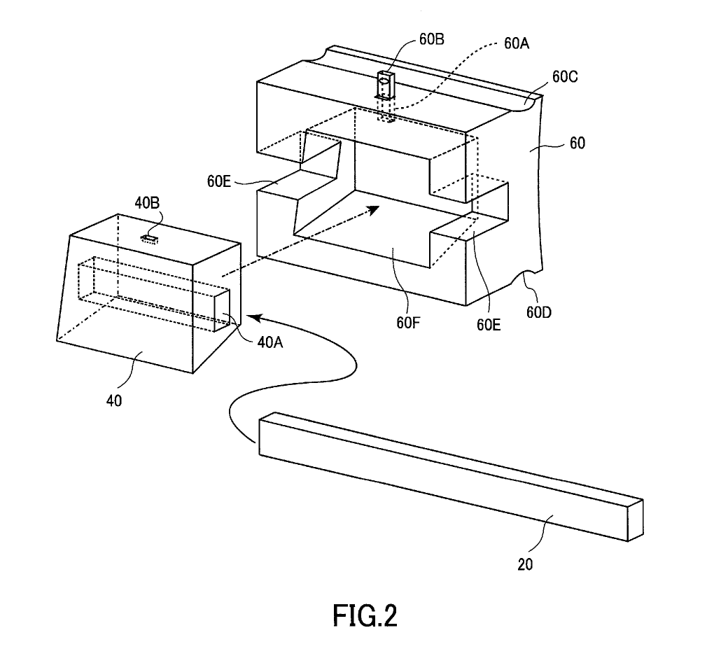

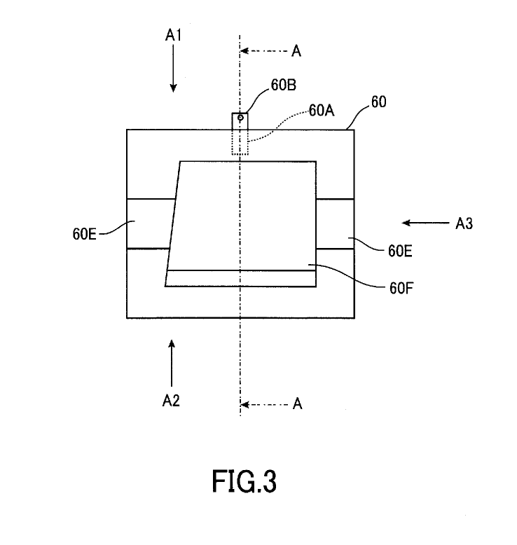

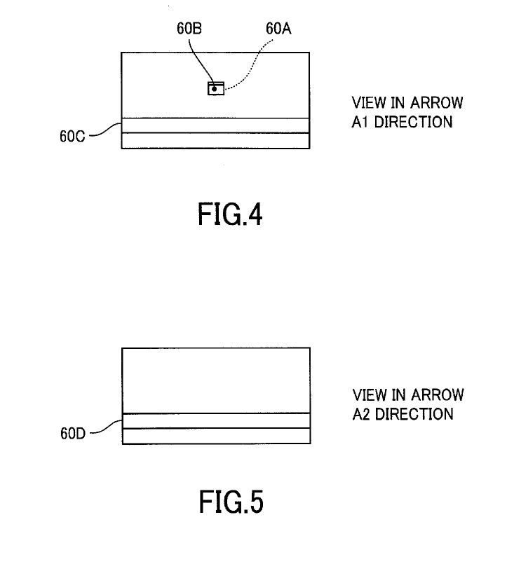

Hereunder, an orthodontic bracket according to an embodiment of the present invention will be described with reference to the drawings. FIG. 1 is a perspective view illustrating the outer appearance of an orthodontic bracket 100 having the basic configuration according to the present embodiment. FIG. 2 is a perspective view illustrating the outer appearance of a wire holder 40 and a bracket base 60 which constitute the orthodontic bracket 100 illustrated in FIG. 1. FIG. 3 is a front view of the orthodontic bracket 100. FIG. 4 is a top view of the orthodontic bracket 100. FIG. 5 is a bottom view of the orthodontic bracket 100. In the following description, a face of the orthodontic bracket 100 that is attached to the tooth surface of a tooth of a patient is defined as a “front face” (surface), a face of the orthodontic bracket 100 that is attached to the tooth surface of a patient is defined as a “back face” (rear face), and among the side faces of the orthodontic bracket 100, a face in which a pin guide hole 60A that is described later is provided is defined as a “top face”, a face on the opposite side thereto is defined as a “bottom face”, a face on the right side as viewed from the front face is defined as a “right-side face”, and a face on the left side as viewed from the front face is defined as a “left-side face”.

An orthodontic bracket 100 according to the present embodiment is used for correcting the dentition of a patient, and a feature of the orthodontic bracket 100 is a self-ligating bracket. The orthodontic bracket 100 of the present embodiment has a wire holder 40 and a bracket base 60. The wire holder 40 includes at least one wire hole (through-hole) 40A through which an arch wire 20 for orthodontic treatment is inserted. The shape of the wire hole 40A is a polygonal shape that is the same as the transverse cross-sectional shape of the arch wire 20, and is typically a square shape, and the internal dimensions of the wire hole 40A are slightly larger than the external dimensions of the arch wire 20 to an extent that allows the arch wire 20 to be inserted therethrough. Thereby, it is possible for the torque of the arch wire 20 to be transmitted to the tooth surface of the patient with little loss.

Note that, in this case the wire holder 40 will be described as a wire holder that has a single wire hole 40A. However, a plurality of the wire holes 40A having the same or different cross-sectional shapes and the same or different cross-sectional dimensions may be provided in the wire holder 40. Further, the orthodontic bracket 100 has a fixing structure for fixing the wire holder 40 that is mounted in the bracket base 60. The bracket base 60 includes a structure for attaching and detaching the wire holder 40 from the surface side of the bracket base 60, and the rear face thereof is affixed using a special-purpose adhesive to the surface of a tooth of the patient. The wire holder 40 and the bracket base 60 are formed of, for example, plastic (synthetic resin), zirconium oxide (zirconia) or ceramic, and preferably, to improve the aesthetic characteristics, for example, are transparent or are formed in a color that is close to the color of a patient's teeth. The wire holder 40 and the bracket base 60 may also be made of a metal such as a gold-silver-palladium alloy. In addition, the wire holder 40 and the bracket base 60 may be formed of mutually different materials, for example, the wire holder 40 may be made of ceramic and the bracket base 60 may be made of metal or the like.

The principal feature of the present embodiment is that the orthodontic bracket 100 is constituted by the wire holder 40 and the bracket base 60 that are separate bodies to each other. A conventional bracket corresponds to the bracket base 60 of the present embodiment. In a conventional self-ligating bracket, the dimensions of the wire slot are fixed, and a gap between an arch wire and the wire slot varies depending on the arch wire that is changed as the need arises during the correction period. Therefore, it is difficult to apply the designed orthodontic force to teeth using a conventional self-ligating bracket. However, according to the present embodiment, by preparing in advance various kinds of the wire holders 40 in which the sizes and shapes of the wire hole 40A are different, and using the wire holders 40 in combination with various kinds of arch wires 20, a gap between the arch wire 20 and the wire hole 40A can be minimized, and the designed orthodontic force can be applied to the teeth. Note that, the term “orthodontic force” refers to a force for moving teeth during orthodontic treatment, and the forms of teeth movement include tipping movement, bodily translation, extrusion, depression, rotation and torque. According to the present embodiment, because a gap between the arch wire 20 and the wire hole 40A can be minimized, among the plurality of kinds of movement forms, the present embodiment exerts an effect in particular with respect to torque movement of teeth.

In addition, conventionally, as intraoral treatment work on a patient that is performed after completing a procedure that fixes a plurality of brackets to the surface of teeth of the patient, the arch wire 20 is sequentially ligated to each of a plurality of brackets using a ligature tool such as a ligature ring or a rubber piece. The work for sequentially ligating the arch wire 20 with a ligature tool takes a long time, and this places a heavy burden on the patient. In the present embodiment, a procedure for fixing a plurality of the bracket bases 60 to the surfaces of the teeth of the patient is performed and completed (this operation itself is the same as in the conventional technology). In a separate process to the aforementioned fixing work, the arch wire 20 is inserted through the wire hole 40A of a plurality of the wire holders 40. This work can be performed outside the oral cavity of the patient. Finally, work to sequentially mount the plurality of wire holders 40 through which the arch wire 20 was passed to a plurality of the bracket bases 60 is performed inside the oral cavity of the patient. A configuration is adopted so that the wire holder 40 as a hexahedron (block body) is fixed in the bracket base 60 by fitting the wire holder 40 into a concave portion (holder slot) 60F of the bracket base 60 which is formed to match the shape of the wire holder 40, and then pushing the wire holder 40 into the holder 60F. Therefore, the operation required to mount the wire holder 40 in the bracket base 60 is simple operation that involves merely fitting the wire holder 40 into the holder slot 60F of the bracket base 60, and then pressing in the wire holder 40, and is significantly simpler than the conventional operation which involves sequentially ligating the wire itself using a ligature tool such as a ligature ring or a rubber piece, and is also completed in a shorter time in comparison to the conventional work. That is, it is possible to reduce to a large degree the amount of time required for intraoral work which is the work that places the greatest burden on the patient, and thus the burden of the patient can be reduced to a large degree. In other words, by constituting the orthodontic bracket 100 using the wire holder 40 and the bracket base 60 that are separate bodies to each other as described in the present embodiment, the work of “sequentially ligating the arch wire 20 to brackets using a ligature tool such as ligature rings or rubber pieces” that has conventionally been performed inside the oral cavity of a patient can be realized by dividing the work into extraoral work and intraoral work.

Hereunder, the structures of the bracket base 60 and the wire holder 40 are described.

As shown in FIG. 3, the pin guide hole 60A is provided as a fixing structure at approximately the center in the transverse direction in the top face of the bracket base 60, and a holder fixing pin 60B for fixing the mounted wire holder 40 is retained therein. In FIG. 1, a state is illustrated in which the holder fixing pin 60B is housed inside the bracket base 60 in order to fix the wire holder 40. The holder fixing pin 60B, for example, is urged in a direction in which the distal end of the holder fixing pin 60B projects into the holder slot 60F of the bracket base 60 by urging means such as a coiled spring or plate spring or a rubber tube, and the distal end is inserted into a pin slot 40B of the wire holder 40 that is housed in the bracket base 60, to thereby maintain a state in which the wire holder 40 is fixed in the bracket base 60. When detaching the mounted wire holder 40 from the bracket base 60, as shown in FIG. 2, the holder fixing pin 60B can be drawn out from inside the bracket base 60 against the urging force.

As shown in FIG. 1, FIG. 2 and FIG. 4, in the top face of the bracket base 60, a groove portion 60C is formed along the edge on the rear face side. Similarly, as shown in FIG. 1, FIG. 2 and FIG. 5, in the bottom face of the bracket base 60, a groove portion 60D is formed along the edge on the rear face side. The groove portions 60C and 60D are provided to make the bracket base 60 easy to hold and thereby facilitate handling of the bracket base 60 when, for example, a dental practitioner performs an operation to affix the bracket base 60 to a tooth of a patient using a special pliers, or to detach the bracket base 60.

A concave holder slot (recession) 60F that houses the wire holder 40 is formed on the surface side of the bracket base 60. The holder slot 60F is formed in conformity with the outer shape of the wire holder 40, and is formed so as to closely contact the wire holder 40 when the wire holder 40 is mounted therein. Thereby the wire holder 40 mounted in the holder slot 60F can be held in a stable state by the bracket base 60. Further, the holder slot 60F is processed so that the area of an inner face that opposes the rear face of the wire holder 40 is less than the area of an opening portion thereof in conformity with the shape of the wire holder 40. That is, by making the size of the rear face of the wire holder 40 smaller than the opening portion of the holder slot 60F, when mounting the wire holder 40, the wire holder 40 is easily inserted into the holder slot 60F of the bracket base 60, and positioning thereof is also made easy. Thereby, the work to mount the wire holder 40 in the bracket base 60 can be facilitated.

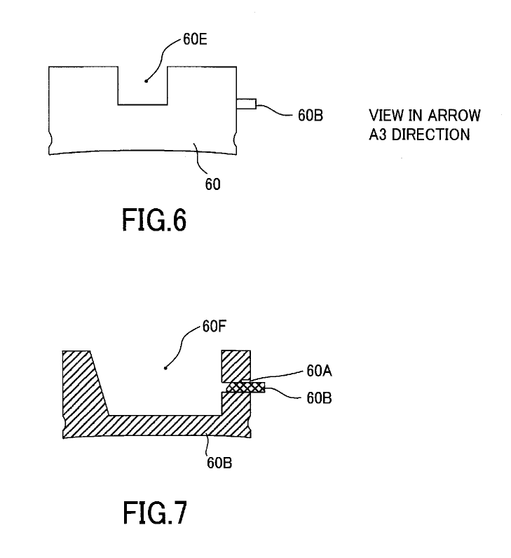

Further, in both side faces of the bracket base 60 is provided a concave wire guide 60E for allowing the arch wire 20 to pass through when mounting the wire holder 40 that is in a state in which the arch wire 20 is inserted therethrough into the holder slot 60F. The width of the wire guide 60E is wider than the maximum width of a common arch wire 20. FIG. 6 is a side view of the wire holder 40. FIG. 7 is a cross-sectional view along a line A-A in FIG. 3 of the wire holder 40. As shown in FIG. 1 and FIG. 6, the wire guide 60E is formed from the surface side to a position of the arch wire 20 when mounted in the wire holder 40, in conformity with the position of the wire hole 40A that is provided in the wire holder 40. The dimension in the vertical direction of the wire guide 60E is formed to be somewhat wider than the height direction of the arch wire 20 in a state in which the arch wire 20 is mounted in the wire hole 40A. Further, as shown in FIG. 7, the dimension in the height direction of the opening portion of the holder slot 60F that is provided in the bracket base 60 is greater than the dimension in the height direction of the inner face. The cross-section of the holder slot 60F is a trapezoid that widens from the inner side to the surface side, in other words, narrows toward the inner side. Although the holder slot 60F is typically a right trapezoid, it may be an isosceles trapezoid. If the holder slot 60F is a right trapezoid, there is the advantage that it is easy to recognize an insertion error, and cutting out from a rectangular parallelepiped block is also comparatively easy. The shape of the holder slot 60F conforms to the shape of the wire holder 40.

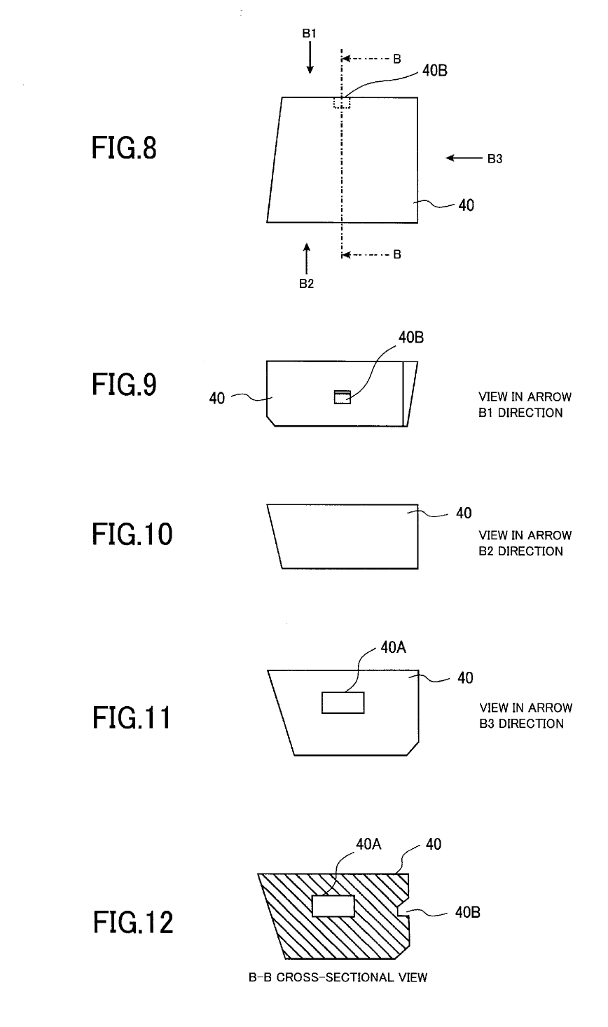

FIG. 8 to FIG. 12 are views that illustrate the outer appearance of the wire holder 40. FIG. 8 is a front view from the surface of the wire holder 40. FIG. 9 is a top view of the wire holder 40. FIG. 10 is a bottom view of the wire holder 40. FIG. 11 is a side view of the wire holder 40. FIG. 12 is a transverse cross-sectional view of the wire holder 40 along a line B-B shown in FIG. 8.

As shown in FIG. 2, the wire holder 40 is a truncated square pyramid shape. The surface and the rear face (inner face) of the wire holder 40 are parallel, and the rear face is smaller than the surface. The surface and the rear face of the wire holder 40 are each a right trapezoid in which an interior angle formed between one of the sides and the lower base is a right angle. That is, as shown in FIG. 8, the surface of the wire holder 40 is a right trapezoid in which the upper base and lower base are parallel, and an interior angle formed between one of the sides and the lower base is a right angle. As shown in FIG. 9 and FIG. 10, one of the top face and the bottom face of the wire holder 40 is a right trapezoid, and the other is a rectangle. As shown in FIG. 11 and FIG. 12, the side-face shape and transverse shape of the wire holder 40 are each a right trapezoid. Note that, the surface of the wire holder 50 may be an isosceles trapezoid in which the upper base and lower base are parallel. Similarly, the side-face shape and surface shape of the wire holder 40 may also be an isosceles trapezoid.

Since the surface shape that is a right trapezoid of the wire holder 40 enables easy visual recognition of the vertical orientation of the wire holder 40, there is the effect that the occurrence of a situation in which a mistake is made regarding the vertical orientation of the wire holder 40 when performing work to pass an arch wire through the wire hole 40A of the wire holder 40 can be easily avoided. Furthermore, since the surface shape is a right trapezoid in which one interior angle is a right angle, the working properties are good and a decrease in production cost in comparison to a case where the surface shape is an isosceles trapezoid can be expected.

By forming the wire holder 40 in a truncated square pyramid shape in which the front side is made wide and the inner side is narrowed, there is an effect of facilitating an action of inserting the wire holder 40 into the holder slot 60F of the bracket base 60, and furthermore a situation in which the wire holder 40 is inserted in an erroneous manner with respect to the vertical orientation thereof can be avoided with certainty.

In other words, a configuration may also be adopted in which the width of the surface of the wire holder 40 is made narrower than the width of the rear face of the wire holder 40. That is, by making the size of the rear face of the wire holder 40 smaller than the opening portion of the holder slot 60F in not just the height direction but also in the width direction, it is possible to further facilitate positioning of the wire holder 40 in the holder slot 60F of the bracket base 60 when mounting the wire holder 40. In this case, the holder slot 60F of the bracket base 60 is formed in conformity with the outer shape of the wire holder 40.

The pin slot 40B is provided as a fixing structure in the vicinity of the center of the top face of the wire holder 40. When the wire holder 40 is mounted in the bracket base 60, the pin slot 40B is communicated with the pin guide hole 60A, and the distal end portion of the holder fixing pin 60B is inserted therein. Because the holder fixing pin 60B is being urged, the distal end of the holder fixing pin 60B is automatically inserted into the pin slot 40B during the course of pushing the wire holder 40 into the holder slot 60F of the bracket base 60. It is possible for the dentist to confirm that the wire holder 40 is fixed in the bracket base 60 by means of a clicking sensation and sound that accompany insertion of the distal end of the holder fixing pin 60B into the pin slot 40B.

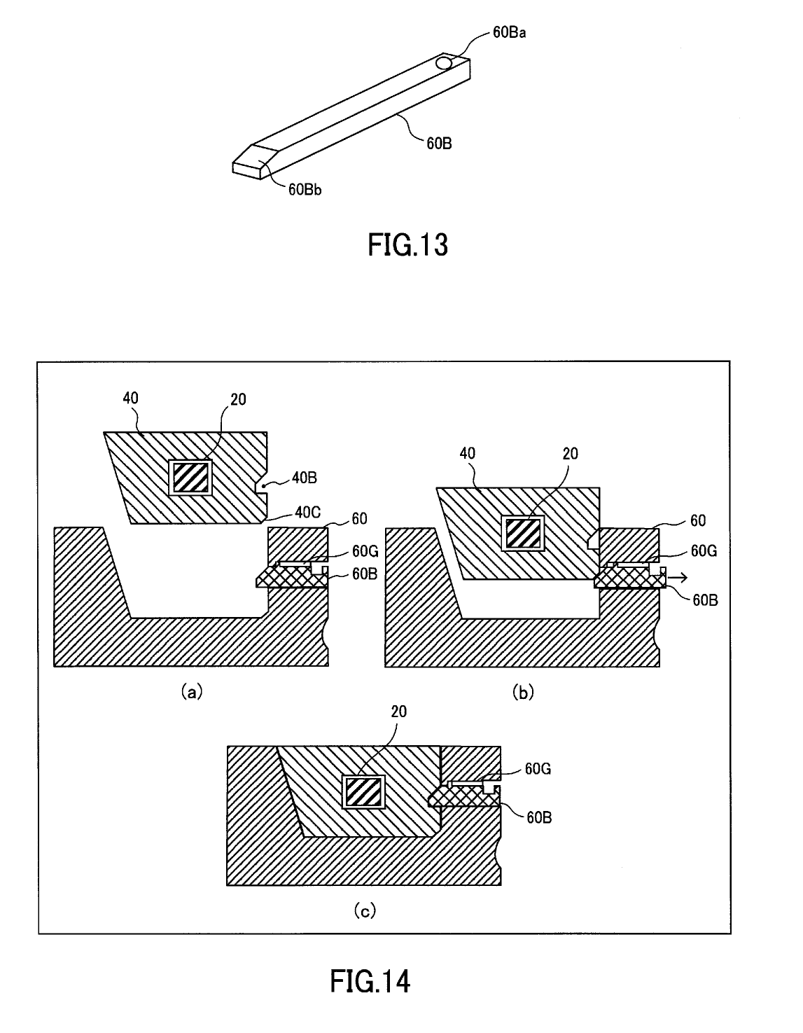

FIG. 13 is a perspective view illustrating the outer appearance of the holder fixing pin 60B. As illustrated in FIG. 13, in the holder fixing pin 60B, a hook hole 60Ba is provided in the vicinity of one end, and an inclined face 60Bb is formed in the vicinity of the other end (distal end portion).

The hook hole 60Ba is used to hook onto a hook when drawing out the holder fixing pin 60B that is in a housed state inside the bracket base 60 (the pin guide hole 60A). Note that, a space into which a hook can be inserted is provided between the face on which the hook hole 60Ba of the holder fixing pin 60B is provided and the inner surface of the pin guide hole 60A. The inclined face 60Bb of the holder fixing pin 60B is provided so that, when mounting the arch wire 20 in the holder slot 60F, the inclined face 60Bb acts to push up the holder fixing pin 60B (so that the holder fixing pin 60B is withdrawn from the inside of the bracket base 60) by contact with the arch wire 20.

FIG. 14(a), FIG. 14(b) and FIG. 14(c) are cross-sectional views along a line A-A in FIG. 3 which illustrate states of the holder fixing pin 60B when mounting the wire holder 40 in the holder slot 60F. As shown in FIG. 14(a), the holder fixing pin 60B is urged in a direction so as to be housed inside the bracket base 60 by an elastic member 60G housed inside the pin guide hole 60A. Further, the inclined face 60Bb of the holder fixing pin 60B is mounted toward the opening portion of the holder slot 60F. Therefore, the inclined face 60Bb of the holder fixing pin 60B is in a state in which the inclined face 60Bb protrudes into the holder slot 60F.

Upon the wire holder 40 being inserted into the holder slot 60F, as shown in FIG. 14(b), a corner 41C formed between the rear face and top face of the wire holder 40 contacts the inclined face 60Bb. Consequently, the holder fixing pin 60B is pushed upward in the direction of the arrow in FIG. 14(b) against the urging by the elastic member 60G. Note that, by chamfering the corner 41C formed between the rear face and top face of the wire holder 40, it is possible to smoothen the action that pushes the holder fixing pin 60B upward by contact with the inclined face 60Bb.

Further, as shown in FIG. 14(b), upon a state being entered in which the wire holder 40 is completely mounted in the holder slot 60F, because the state is one in which the pin guide hole 60A and the pin slot 40B communicate, the distal end portion of the holder fixing pin 60B that had been pushed upward is inserted into the pin slot 40B. As shown in FIG. 14(a) to (c), the pin slot 40B is formed so that a face on the rear face side is the same direction as the insertion direction of the holder fixing pin 60B, that is, so as to be perpendicular from the top face. Therefore, by the distal end portion of the holder fixing pin 60B being inserted into the pin slot 40B, the holder fixing pin 60B can maintain a state in which the wire holder 40 housed in the bracket base 60 is locked and fixed.

Note that, although in the foregoing description it is described that the holder fixing pin 60B is urged by the elastic member 60G in a direction such that the holder fixing pin 60B is housed inside the bracket base 60, it is possible to omit the elastic member 60G by causing the holder fixing pin 60B to be retained by means of the pin guide hole 60A in a manner such that the holder fixing pin 60B does not easily slide, by raising the coefficient of friction between the holder fixing pin 60B and the pin guide hole 60A or the like. In this case, when inserting the wire holder 40 into the holder slot 60F, when the holder fixing pin 60B is pushed upward as described in the foregoing, although the holder fixing pin 60B remains in the state in which it has been pushed upward, when mounting of the wire holder 40 is completed it is possible to simply fix the wire holder 40 by merely pushing down the upper end of the holder fixing pin 60B.

The arch wire 20 that is to be mounted in the orthodontic bracket 100 of the present embodiment has, for example, a transverse cross-sectional shape that is a rectangle as shown in FIG. 1 and FIG. 2. The transverse cross-sectional shape of the arch wire 20 may also be a square or a polygonal shape such as a hexagon, or may also be elliptical shape or a circular shape. Various kinds of wire holders 40 that have wire holes 40A of various shapes that are in accordance with the various shapes of the arch wire 20 are prepared.

The opening portion of the wire hole 40A provided in the wire holder 40 is formed in a size and a shape such that the arch wire 20 can pass therethrough. A feature of the orthodontic bracket 100 of the present embodiment is the self-ligating bracket, and the self-ligating bracket does not completely fix the arch wire 20 by means of the wire holder 40. Therefore, the size of the opening portion of the wire hole 40A is basically smaller than the cross-section of the arch wire 20. Note that, depending on the tooth to which the orthodontic bracket 100 is attached, it is also possible to fix the arch wire 20 in the wire hole 40A.

When mounting the arch wire 20 in the orthodontic bracket 100, the arch wire 20 is inserted through the wire hole 40A of the wire holder 40 in advance, and the wire holder 40 is then mounted in the holder slot 60F as described above. Normally, the orthodontic bracket 100 is attached to a plurality of teeth when performing orthodontic treatment, and it is necessary to attach the arch wire 20 to the plurality of orthodontic brackets 100. In the case of the orthodontic bracket 100 of the present embodiment, after inserting the arch wire 20 through a plurality of the wire holders 40 that are to be mounted in a plurality of the orthodontic brackets 100, respectively, a procedure can be performed on the patient. That is, as the procedure that is performed on the patient, it suffices to merely insert the holder slots 60F which are respectively positioned into the bracket bases 60 that correspond to a plurality of the wire holders 40. Hence, because mounting of the wire holders 40 (the arch wire 20) to the bracket base 60 is easy, the procedure time can be shortened.

According to the present embodiment, when using different arch wires of various thicknesses in an appropriate manner according to the required orthodontic force, a wire holder having a wire hole whose internal dimensions conform to the thickness of the relevant arch wire can be selected and used from among a plurality of kinds of wire holders having various wire holes that have different internal dimensions. Thereby, gaps between the arch wire and the wire holes are eliminated, and a loss in orthodontic force can be eliminated.

Further, although in FIG. 2, FIG. 11 and FIG. 12 the wire hole 40A of the wire holder 40 is formed to have a rectangular opening face that matches the transverse cross-sectional shape of the arch wire 20, and in which the long sides are vertical (parallel to the rear face of the wire holder 40), the wire holder 40 may be formed in a state in which the rectangular shape of the opening face is inclined. That is, by changing the orientation of the wire hole 40A, it is possible to adjust the orthodontic force that is applied by the arch wire 20. As described in the foregoing, it is possible to adjust the orthodontic force by preparing a plurality of kinds of wire holders 40 in which the orientation of the arch wire 20 is different, and selecting the wire holder 40 according to the stage of orthodontic treatment or the teeth which are the object of the treatment.

Thus, the wire holder 40 according to the present embodiment simplifies mounting of the arch wire 20 to the orthodontic bracket 100, and can also be used to adjust the orthodontic force.

### First Modification

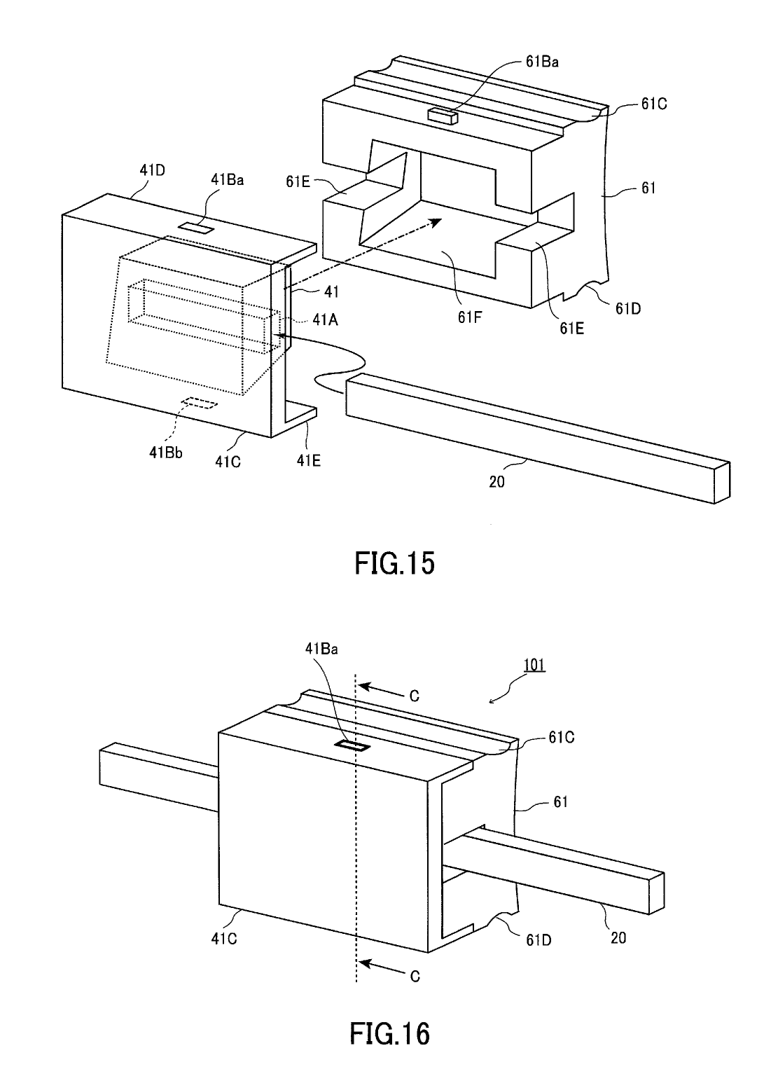

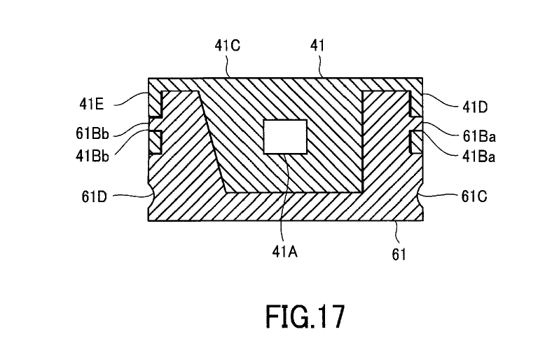

Next, an orthodontic bracket 101 according to a first modification of the present embodiment will be described referring to FIG. 15, FIG. 16 and FIG. 17. FIG. 15 is a perspective view illustrating the outer appearance of a wire holder 41 and a bracket base 61 that constitute the orthodontic bracket 101 according to the first modification. FIG. 16 is a perspective view illustrating the outer appearance of the orthodontic bracket 101. FIG. 17 is a cross-sectional view of the orthodontic bracket 101 along a line C-C in FIG. 16. Note that, components that are the same as in the basic configuration illustrated in FIG. 1 to FIG. 14 are assigned the same names as in the basic configuration and a description of such components is omitted hereunder.

The orthodontic bracket 101 of the first modification has the wire holder 41 and the bracket base 61. The wire holder 41 includes a wire hole 41A through which the arch wire 20 for orthodontic treatment is inserted. As shown in FIG. 15, in the vicinity of the front face at approximately the center in the transverse direction, locking protrusions 61Ba and 61Bb are provided (the locking protrusion 61Bb is shown in FIG. 17) as fixing structures for fixing the wire holder 41 that has been mounted to the bracket base 61 to the top face and bottom face, respectively, of the bracket base 61. Further, groove portions 61C and 61D, a wire guide 61E and a holder slot 61F are provided in the bracket base 61.

On the other hand, a bracket cover 41C is formed on the front face side of the wire holder 41. The bracket cover 41C is formed in approximately the same size lengthwise and breadthwise as the front face of the bracket base 61 so that the bracket cover 41C can cover the entire front face of the bracket base 61. To enhance the aesthetic characteristics, for example, the bracket cover 41C is transparent or is formed in a color that is close to the color of a patient's teeth. Extension portions 41D and 41E that are extended to the rear face (the bracket base 61) side are formed at the upper end and lower end, respectively, of the bracket cover 41C. As shown in FIG. 16 and FIG. 17, the extension portions 41D and 41E are formed so that, when the wire holder 41 is mounted in the bracket base 61, the extension portions 41D and 41E are brought into intimate contact with the top face and bottom face, respectively, of the bracket base 61. Mounting holes 41Ba and 41Bb are provided at approximately the center in the width direction of the extension portions 41D and 41E. The mounting holes 41Ba and 41Bb serve as a fixing mechanism for locking the locking protrusions 61Ba and 61Bb of the bracket base 61 in a case where the wire holder 41 is mounted in the bracket base 61. Upon the wire holder 41 being mounted in the bracket base 61, the locking protrusions 61Ba and 61Bb are passed through the mounting holes 41Ba and 41Bb, respectively. Thereby, the wire holder 41 that has been mounted in the bracket base 61 is fixed.

The wire holder 41 of the first modification is formed, for example, of plastic (synthetic resin) so as to have elasticity (flexibility). That is, the wire holder 41 is formed so that the space between the extension portions 41D and 41E widens when a force is applied in the upward direction to the extension portion 41D and in the downward direction to the extension portion 41E.

In the case of mounting the wire holder 41 to the bracket base 61, the wire holder 41 is inserted into the holder slot 61F in a state in which the area between the extension portions 41D and 41E has been expanded, and the extension portions 41D and 41E are returned to their original state after mounting is completed. Thereby the locking protrusions 61Ba and 61Bb are fitted into the mounting holes 41Ba and 41Bb, respectively.

When taking the wire holder 41 out from the bracket base 61, similarly to the above described procedure, the fixed state between the locking protrusions 61Ba and 61Bb and the mounting holes 41Ba and 41Bb can be released by expanding the area between the extension portions 41D and 41E, and drawing the wire holder 41 out from the holder slot 61F in that state.

Note that, although in the illustrations in FIG. 15 to FIG. 17, fixing structures are formed at two places on the top face and the bottom face of the bracket base 61 and the wire holder 41, a fixing structure may be provided at only one place as long as it is possible to maintain the fixed state of the mounted wire holder 41. Further, in FIG. 15 and FIG. 17, although each of the locking protrusions 61Ba and 61Bb is formed as substantially a rectangular parallelepiped that extends in the vertical direction from the bracket base 61, a configuration may also be adopted in which an inclined face is formed on the front face side (side from which the wire holder 41 is mounted). Thereby, by moving the wire holder 41 in the direction in which the wire holder 41 is mounted in the bracket base 61 to cause the ends of the extension portions 41D and 41E to contact against the inclined face portions of the locking protrusions 61Ba and 61Bb, and thereafter further moving the wire holder 41, the extension portions 41D and 41E can be expanded along the inclined face portions. Upon the wire holder 41 being pushed in as far as a position at which the wire holder 41 is completely mounted, the locking protrusions 61Ba and 61Bb pass through the mounting holes 41Ba and 41Bb, and the extension portions 41D and 41E return to their original state. Thus, a state is entered in which the wire holder 41 and the bracket base 61 are fixed. Therefore, when mounting the wire holder 41 in the bracket base 61, the wire holder 41 can be simply mounted in the bracket base 61 and placed in a fixed state by merely pushing in the wire holder 41 in the direction for mounting the wire holder 41 in the bracket base 61, and without performing work to widen the space between the extension portions 41D and 41E in advance.

Thus, by using the wire holder 41, the orthodontic bracket 101 of the first modification has similar operational advantages to the orthodontic bracket 100 having the basic configuration that is described above. In addition, in the orthodontic bracket 101, because the entire front face of the bracket base 61 is covered by the bracket cover 41C when the wire holder 41 has been mounted in the bracket base 61, by forming the bracket cover 41C in a color that is inconspicuous or the like, the aesthetic characteristics when the orthodontic bracket 101 is seen from the front face can be improved.

### Second Modification

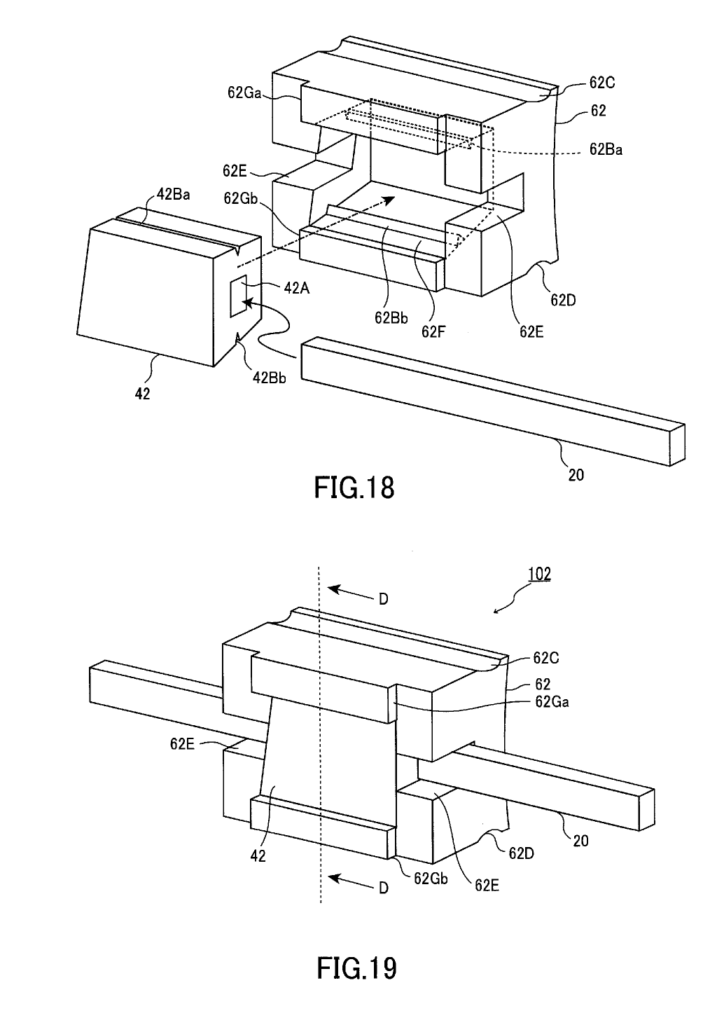

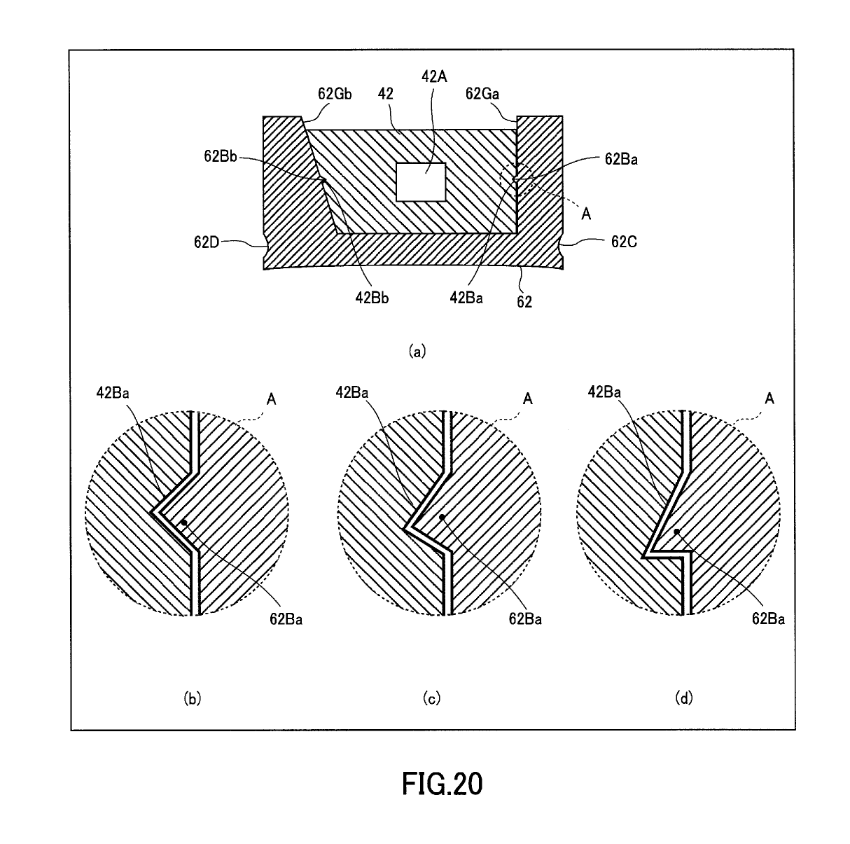

Next, an orthodontic bracket 102 according to a second modification of the present invention will be described referring to FIG. 18, FIG. 19 and FIG. 20. FIG. 18 is a perspective view illustrating the outer appearance of a wire holder 42 and a bracket base 62 that constitute the orthodontic bracket 102 according to the second modification. FIG. 19 is a perspective view illustrating the outer appearance of the orthodontic bracket 102. FIG. 20(a) is a cross-sectional view of the orthodontic bracket 102 along a line D-D in FIG. 19. FIG. 20(b) is an enlarged view of an area indicated by a frame line A in FIG. 20(a). FIG. 20(c) and FIG. 20(d) are enlarged views illustrating other shapes of a locking protrusion 62Ba shown in FIG. 20(b). Note that, components that are the same as in the basic configuration illustrated in FIG. 1 to FIG. 14 are assigned the same names as in the basic configuration and a description of such components is omitted hereunder.

The orthodontic bracket 102 of the second modification has the wire holder 42 and the bracket base 62. The wire holder 42 includes a wire hole 42A through which the arch wire 20 for orthodontic treatment is inserted. As shown in FIG. 18 and FIG. 20(a), as fixing structures for fixing the wire holder 42 that has been mounted to the bracket base 62, linear locking protrusions (linear protrusions) 62Ba and 62Bb are provided at the top face and the bottom face, respectively, on the inside of a holder slot 62F in the bracket base 62. The locking protrusions 62Ba and 62Bb, for example, are formed along the entire the holder slot 62F in the transverse direction at any position (for example, at approximately the center position) in the depth direction on the inner side of the holder slot 62F. Note that, a configuration may also be adopted in which the locking protrusions 62Ba and 62Bb are formed in the transverse direction at one part on the inner side of the holder slot 62F. Typically, the locking protrusions 62Ba and 62Bb are formed at the same depth of the holder slot 62F, in other words, are formed at the same height from the bottom face of the holder slot 62F. Naturally, the locking protrusions 62Ba and 62Bb may also be formed at different depths of the holder slot 62F, in other words, at mutually different heights from the bottom face of the holder slot 62F.

In a case where the locking protrusions 62Ba and 62Bb are provided at the same depth of the holder slot 62F, a configuration is adopted so that the inter-vertex distance (clearance distance) between the locking protrusions 62Ba and 62Bb is somewhat longer than the distance between the upper edge and lower edge of the distal end face of the wire holder 42, that is, the height, and is a distance that enables insertion of the wire holder 42 into the holder slot 62F without the locking protrusions 62Ba and 62Bb interfering with the distal end face of the wire holder 42 during insertion.

As shown in FIG. 20(b), the locking protrusions 62Ba and 62Bb are linear protrusions having a cross-section that is an isosceles triangle shape, and the surface thereof inclines inward with respect to the depth direction of the holder slot 62F. Further, groove portions 62C and 62D, wire guides 62E and the holder slot 62F are provided in the bracket base 62. In addition, in the bracket base 62 parts of the surface on the top face side and the bottom face side in a range in which the holder slot 62F is formed are extended to form extension portions 62Ga and 62Gb. As shown in FIG. 19, the extension portions 62Ga and 62Gb are formed so as to protrude by a small amount relative to the surface of the wire holder 42 in a state in which the wire holder 42 is mounted in the bracket base 62.

On the other hand, mounting slots (mounting grooves) 42Ba and 42Bb are provided along the entire area in the transverse direction of the top face and the bottom face, respectively, of the wire holder 42 as fixing mechanisms for locking the locking protrusions 62Ba and 62Bb of the bracket base 62 when the wire holder 42 is mounted in the bracket base 62. Note that, a configuration may also be adopted in which the mounting slots 42Ba and 42Bb are respectively provided at only one part of the wire holder 42 in the transverse direction. When the wire holder 42 is being mounted into the bracket base 62, the locking protrusions 62Ba and 62Bb on the inside of the holder slot 62F are inserted into the mounting slots 42Ba and 42Bb, respectively. Thereby, the wire holder 42 that is mounted in the bracket base 62 is fixed.

The bracket base 62 of the second modification is formed, for example, of plastic (synthetic resin) so as to have elasticity (flexibility). That is, the bracket base 62 is formed so that the holder slot 62F of the bracket base 62 can be pressed to expand and deform when inserting the wire holder 42 into the holder slot 62F of the bracket base 62. Because the wire guides 62E are provided in both side faces of the bracket base 62, it is easy for the holder slot 62F to expand in the vertical direction.

In the orthodontic bracket 102 of the second modification, mounting/detachment of the wire holder 42 with respect to the bracket base 62 are realized by deformation of the bracket base 62, specifically, by outward bending that expands the opening. In the case of mounting the wire holder 42 in the bracket base 62, the wire holder 42 is inserted into the holder slot 62F and presses against the inner surface of the holder slot 62F to thereby cause the bracket base 62 to deform. Insertion of the wire holder 42 by pressing against the holder slot 62F without catching on the locking protrusions 62Ba and 62Bb is realized as a result of the fact that the respective surfaces of the locking protrusions 62Ba and 62Bb incline with respect to the direction in which the wire holder 42 is inserted into the holder slot 62F. Therefore, the cross-sectional shape of the locking protrusions 62Ba and 62Bb is not. limited to an isosceles triangle shape.

For example, as shown in FIG. 20(c), the cross-sectional shape of the locking protrusions 62Ba and 62Bb may be a triangular shape in which the base angles are not equal. The locking protrusions 62Ba and 62Bb are formed so that a face at which an inclination with respect to the depth direction of the holder slot 62F is gradual faces the opening of the holder slot 62F, and a face at which an inclination is steep faces the bottom face of the holder slot 62F. The wire holder 42 is mounted into the holder slot 62F while deforming along the face with the gradual inclination, and is detached from the holder slot 62F along the face with the steep inclination. Therefore, the amount of deformation of the wire holder 42 that is required per unit distance when detaching the wire holder 42 is greater than the amount of deformation when mounting the wire holder 42. That is, the external force that is required when detaching the wire holder 42 from the holder slot 62F is greater than the external force that is required when mounting the wire holder 42 in the holder slot 62F. Thereby, in comparison to a case where the cross-sectional shape of each of the locking protrusions 62Ba and 62Bb is an isosceles triangle, it is easier to mount the wire holder 42 in the bracket base 62 and it is more difficult for the wire holder 42 to fall out from the bracket base 62. Similarly, as shown in FIG. 20(d), the cross-sectional shape of each of the locking protrusions 62Ba and 62Bb may be a right-angled triangle. In this case, the locking protrusions 62Ba and 62Bb are formed so that the inclined face thereof faces the opening of the holder slot 62F. Note that, the cross-sectional shape of the locking protrusions 62Ba and 62Bb is not limited to a triangular shape, and for example may be an arc shape.

Upon the wire holder 42 being pushed in and reaching the innermost mounting position, the locking protrusions 62Ba and 62Bb provided in the holder slot 62F are inserted into the mounting slots 42Ba and 42Bb of the wire holder 42 to thereby realize a fixed state between the wire holder 42 and the bracket base 62. Further, when detaching the wire holder 42 from the bracket base 62, by placing the space between the extension portions 62Ga and 62Gb in an expanded state and drawing out the wire holder 42 from the holder slot 62F, the fixed state between the locking protrusions 62Ba and 62Bb and the mounting slots 42Ba and 42Bb can be released.

Note that, although in FIG. 18 a configuration is illustrated in which the locking protrusions 62Ba and 62Bb are formed across the entire holder slot 62F in the transverse direction, the locking protrusions 62Ba and 62Bb may be provided at one part in the transverse direction, and may also be a different shape as long as the shape is one that can engage with the fixing structures provided in the wire holder 42.

Further, although a configuration is described above in which the bracket base 62 is formed to have elasticity (flexibility), a configuration may also be adopted in which the bracket base 62 is formed so that the external shape thereof does not deform, and only the locking protrusions 62Ba and 62Bb are formed to be deformable. Thereby, it is possible to not apply a load to the bracket base 62 in a state in which the bracket base 62 is attached to a tooth of a patient.

Thus, by using the wire holder 42, the orthodontic bracket 102 of the second modification has similar operational advantages to the orthodontic bracket 100 having the basic configuration that is described above. In addition, in the orthodontic bracket 102, because the bracket base 62 can be deformed by insertion of the wire holder 42 and thereby allow mounting of the wire holder 42, it is not necessary to maintain the bracket base 62 in a deformed state before insertion of the wire holder 42, and thus mounting of the wire holder 42 can be simplified.

Note that, although it is described above that the locking protrusions (linear protrusions) 62Ba and 62Bb are provided in the holder slot 62F of the wire holder 42, and the mounting slots (mounting grooves) 42Ba and 42Bb into which the locking protrusions 62Ba and 62Bb are to be fitted are provided in the wire holder 42, in order to improve the ease of production and the yield, a configuration may also be adopted in which the mounting slots (mounting grooves) 42Ba and 42Bb are provided in the holder slot 62F for the wire holder 42, and the locking protrusions (linear protrusions) 62Ba and 62Bb that are to be fitted into the mounting slots 42Ba and 42Bb are provided in the wire holder 42. The fact that a configuration may also be adopted in which mounting slots (mounting grooves) are provided in a holder slot for a wire holder, and locking protrusions (linear protrusions) that are to be fitted into the mounting slots are provided in the wire holder similarly applies to the descriptions hereunder.

### Third Modification

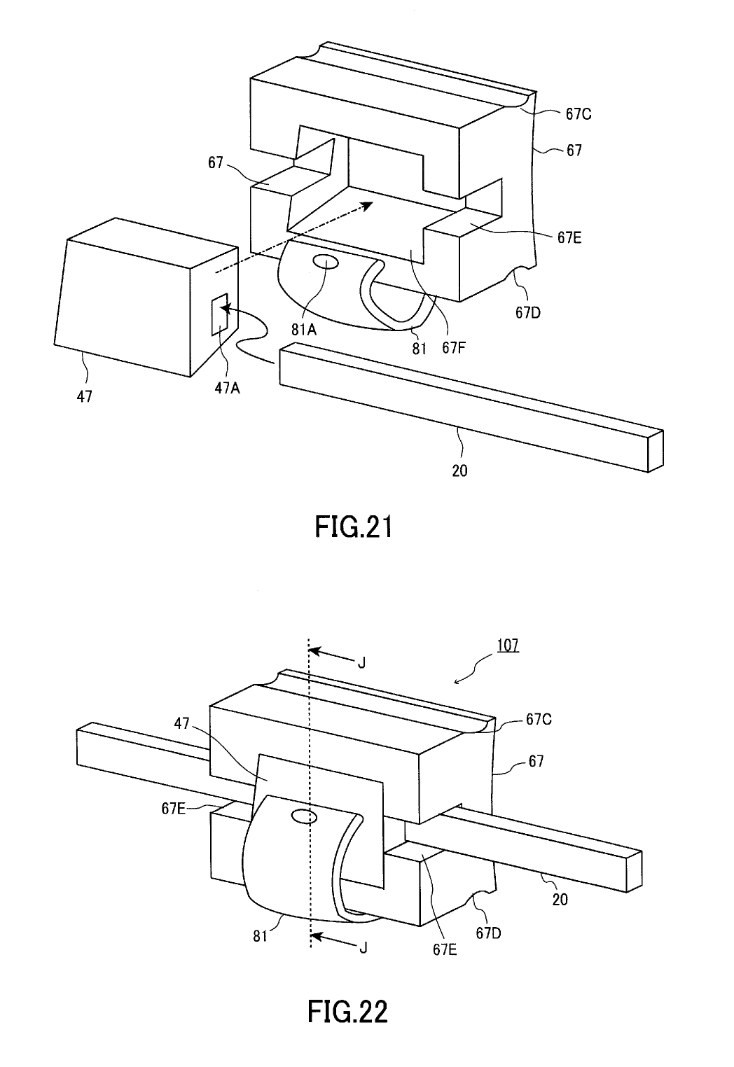

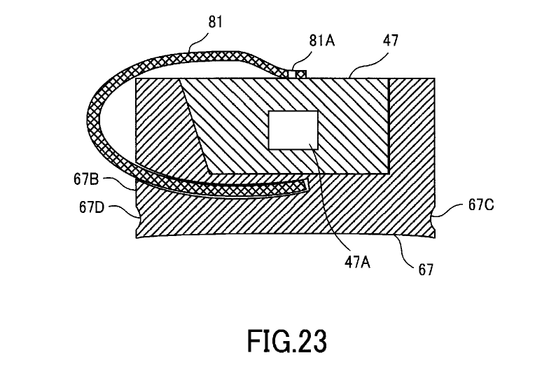

Next, an orthodontic bracket 107 according to a third modification of the present invention will be described referring to FIG. 21, FIG. 22 and FIG. 23. FIG. 21 is a perspective view illustrating the outer appearance of a wire holder 47 and a bracket base 67 that constitute the orthodontic bracket 107 according to the third modification. FIG. 22 is a perspective view illustrating the outer appearance of the orthodontic bracket 107. FIG. 23 is a cross-sectional view of the orthodontic bracket 107 along a line J-J in FIG. 22. Note that, components that are the same as in the basic configuration illustrated in FIG. 1 to FIG. 14 are assigned the same names as in the basic configuration and a description of such components is omitted hereunder. Further, the orthodontic bracket 107 of the third modification has a configuration in which fixing structures that are different from the basic configuration are provided, and the remaining configuration is basically the same as that of the orthodontic bracket 100.

The orthodontic bracket 107 according to the third modification has a wire holder 47 and a bracket base 67. The wire holder 47 has a wire hole 47A through which the arch wire 20 for orthodontic treatment is inserted. Further, groove portions 67C and 67D, wire guides 67E, and a holder slot 67F are provided in the bracket base 67. In addition, a clip 81 is provided as a fixing structure in the bracket base 67.

As shown in FIG. 23, the cross-sectional shape of the clip 81 is approximately U-shaped, and the clip 81 is formed of an elastically deformable member such as metal. One end of the clip 81 is extended to the surface of the bracket base 67. A hook hole 81A that is used for hooking a hook when performing work with respect to the clip 81 is provided in the vicinity of the one end of the clip 81. Further, the other end of the clip 81 is extended to the bottom face of the bracket base 67, and is inserted in a clip holding slit 67B provided in the bottom face of the bracket base 67.

When mounting the wire holder 47 into the bracket base 67, as shown in FIG. 21, one end of the clip 81 can be pushed down so that the opening face of the holder slot 67F is opened. At this time, as shown in FIG. 21, the distal end portion of the clip 81 is locked to the lower portion of the surface of the bracket base 67. Thereby, work to insert the wire holder 47 into the holder slot 67F can be simply performed without performing an operation with respect to the clip 81.

After mounting the wire holder 47 in the holder slot 67F, as shown in FIG. 22, the distal end portion of the clip 81 is pressed against the surface of the wire holder 47. Thereby a fixed state can be achieved between the wire holder 47 and the bracket base 67. In a case where the clip 81 is used, a fixed state is maintained as long as the distal end of the clip 81 is pressed against any position on the surface of the wire holder 47. Therefore, even if a load is applied to the clip 81 after mounting the wire holder 47 and a certain amount of displacement occurs, the fixed state can be stably maintained. Further, when taking the wire holder 47 out from the holder slot 67F, the clip 81 is placed in the state shown in FIG. 21 that is described above. In this state, an operation can be performed to simply take the wire holder 47 out from the holder slot 67F.

Thus, by using the wire holder 47, the orthodontic bracket 107 of the third modification has similar operational advantages to the orthodontic bracket 100 having the basic configuration that is described above. In addition, in the orthodontic bracket 107, because the clip 81 that is formed of an elastically deformable member is used, the wire holder 47 mounted in the bracket base 67 can be stably placed in a fixed state by a simple operation.

### Fourth Modification

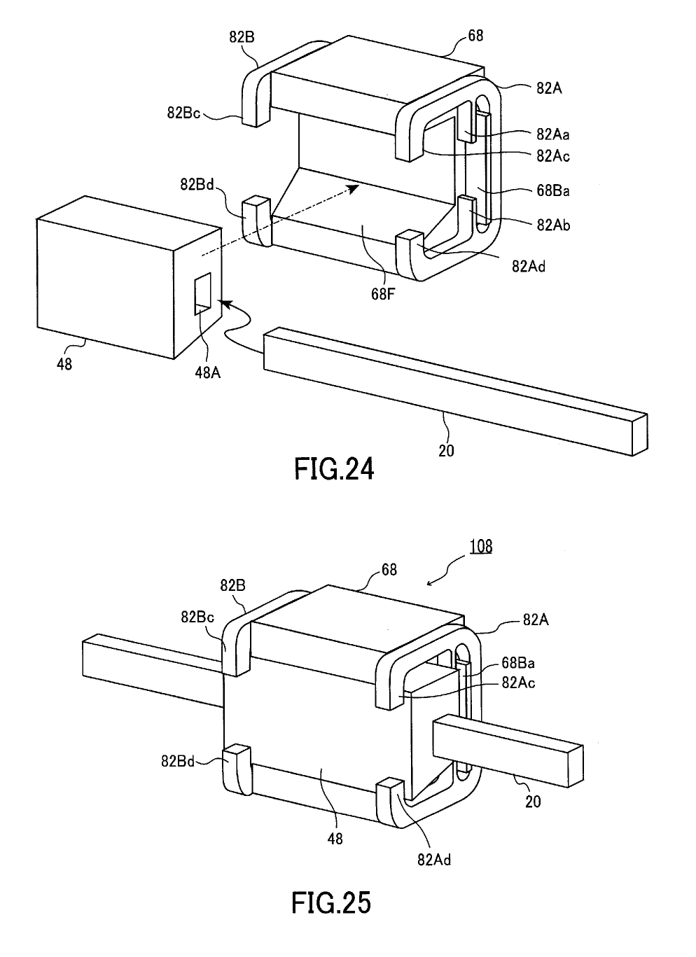

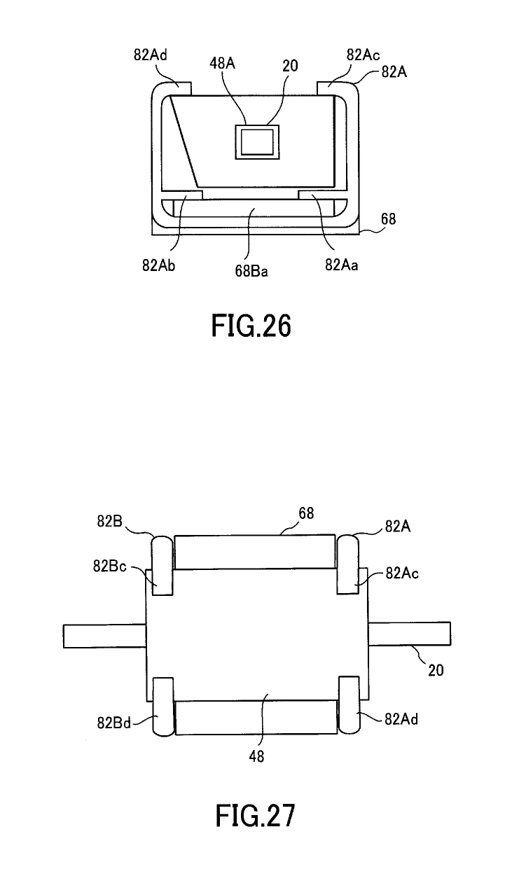

Next, an orthodontic bracket 108 according to a fourth modification of the present invention will be described referring to FIG. 24, FIG. 25, FIG. 26 and FIG. 27. FIG. 24 is a perspective view illustrating the outer appearance of a wire holder 48, a bracket base 68 and clips 82A and 82B that constitute the orthodontic bracket 108 according to the fourth modification. FIG. 25 is a perspective view illustrating the outer appearance of the orthodontic bracket 108. FIG. 26 is a side view of the orthodontic bracket 108 shown in FIG. 25. FIG. 27 is a front view of the orthodontic bracket 108 shown in FIG. 25. Note that, components that are the same as in the basic configuration illustrated in FIG. 1 to FIG. 14 are assigned the same names as in the basic configuration and a description of such components is omitted hereunder.

The orthodontic bracket 108 according to the fourth modification has the wire holder 48, the bracket base 68 and the two clips 82A and 82B. The wire holder 48 has a wire hole 48A through which the arch wire 20 for orthodontic treatment is inserted. The wire holder 48 is configured similarly to the wire holder 41 of the basic configuration. A holder slot 68F is provided in the bracket base 68. In the fourth modification, a structure is adopted in which both side faces of the holder slot 68F are open. The size of the holder slot 68F in the transverse direction is made smaller than the size of the wire holder 48 in the transverse direction. Further, a clip mounting plate 68Ba is formed in the longitudinal direction in the vicinity of the rear face side at both side faces of the bracket base 68.

As shown in FIG. 24 to FIG. 26, the outer shape of the clips 82A and 82B forms an approximately C-shape, and the clips 82A and 82B are mounted to the bracket base 68 in a manner such that the open side is the surface side. The outer shape of the clips 82A and 82B is formed in conformity with the outer shape of the bracket base 68, and portions corresponding to the top and bottom faces and rear face of the bracket base 68 are formed in an approximately rectilinear shape. In the portions corresponding to the top and bottom faces of the clips 82A and 82B, plate-like holding members 82Aa and 82Ab are formed in the vicinity of the portion corresponding to the rear face. The plate-like holding member 82Aa is formed so as to extend in the downward direction from the portion corresponding to the top face of each of the clips 82A and 82B, and so as to leave a space corresponding to the thickness of the clip mounting plate 68Ba between the plate-like holding member 82Aa and the portion corresponding to the rear face. The plate-like holding members 82Ab is formed so as to extend in the upward direction from the portion corresponding to the bottom face of each of the clips 82A and 82B, and so as to leave a space corresponding to the thickness of the clip mounting plate 68Ba between the plate-like holding member 82Ab and the portion corresponding to the rear face. Note that, although the detailed structure of the clip 82B is not illustrated in the drawings, the clip 82B is formed similarly to the clip 82A and hence a description thereof is omitted here.

When mounting the wire holder 48 in the bracket base 68, the clips 82A and 82B are placed in a detached state. After the wire holder 48 is mounted in the holder slot 68F, the clips 82A and 82B are mounted from the sides of the two side faces of the bracket base 68, respectively. As shown in FIG. 26, the clip 82A can be mounted to the bracket base 68 by sandwiching the clip mounting plate 68Ba between the portion corresponding to the rear face and the plate-like holding members 82Aa and 82Ab. The clip 82B is mounted in a similar manner.

Further, distal end portions 82Ac and 82Ad of the clip 82A are each pressed against the surface of the wire holder 48, as shown in FIG. 25 to FIG. 27. Thereby, a fixed state can be realized between the wire holder 48 and the bracket base 68.

Note that although in the configuration illustrated in FIG. 24 to FIG. 27 the wire holder 48 is fixed using the two clips 82A and 82B located at the two side faces of the bracket base 68, it is also possible to fix the wire holder 48 using only either one of the clips 82A and 82B.

Thus, by using the wire holder 48, the orthodontic bracket 108 of the fourth modification has similar operational advantages to the orthodontic bracket 100 having the basic configuration that is described above. In addition, in the orthodontic bracket 108, by using the clips 82A and 82B, the wire holder 48 can be easily placed in a fixed state at the side faces of the bracket base 68.

### Fifth Modification

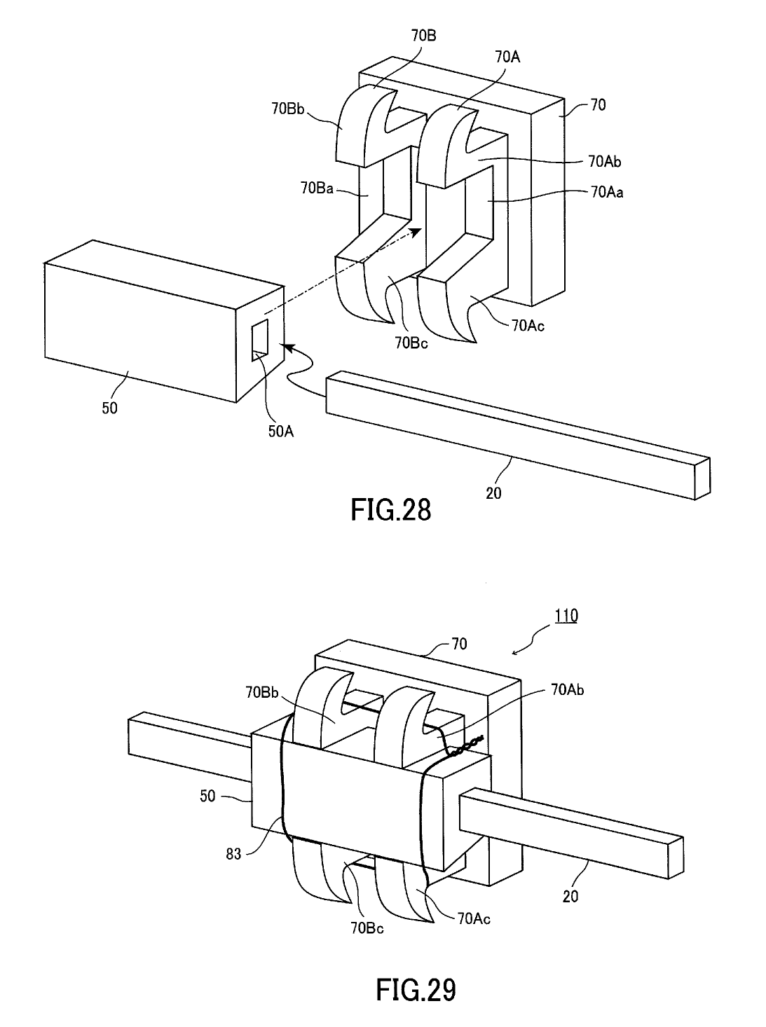

Next, an orthodontic bracket 110 according to a fifth modification of the present invention will be described referring to FIG. 28 and FIG. 29. FIG. 28 is a perspective view illustrating the outer appearance of a wire holder 50 and a bracket base 70 that constitute the orthodontic bracket 110 according to the fifth modification. FIG. 29 is a perspective view illustrating the outer appearance of the orthodontic bracket 110. Note that, components that are the same as in the basic configuration illustrated in FIG. 1 to FIG. 14 are assigned the same names as in the basic configuration and a description of such components is omitted hereunder.

The orthodontic bracket 110 according to the fifth modification includes the wire holder 50 and the bracket base 70. The wire holder 50 has a wire hole 50A through which the arch wire 20 for orthodontic treatment is inserted. A pair of wings 70A and 70B is formed on the surface of the bracket base 70. The wings 70A and 70B form holders 70Aa and 70Ba for holding the wire holder 50. Furthermore, ligature portions 70Ab, 70Ac, 70Bb and 70Bc for hooking a ligating wire (or ligating rubber piece) 83 for fixing the wire holder 50 that is held in the holder are formed in the wings 70A and 70B. The wings 70A and 70B extend from the base portion of the bracket base 70.

As shown in FIG. 28 and FIG. 29, in the wing 70A, the holder 70Aa is formed in conformity with the outer shape of the wire holder 50 between the two ligature portions 70Ab and 70Ac that extend from the base. Likewise, in the wing 70B, the holder 70Ba is formed in conformity with the outer shape of the wire holder 50 between the two ligature portions 70Bb and 70Bc that extend from the base. By providing the pair of wings 70A and 70B at a distance from each other, the wire holder 50 can be stably held by the holders 70Aa and 70Ba.

As shown in FIG. 29, the wire holder 50 that is held by the holders 70Aa and 70Ba can be placed in a fixed state by binding the wire holder 50 using the ligating wire (or ligating rubber piece) 83 that passes from the surface of the wire holder 50 through the rear faces of the ligature portions 70Ab, 70Ac, 70Bb and 70Bc.

Thus, by using the wire holder 50, the orthodontic bracket 110 of the fifth modification has similar operational advantages to the orthodontic bracket 100 having the basic configuration that is described above. In addition, in the orthodontic bracket 110, the wire holder 50 can be fixed using a ligature technique that is already used for the conventional orthodontic brackets. In the orthodontic bracket 110, because the arch wire 20 is held by being inserted through the wire hole 50A of the wire holder 50, the orthodontic bracket 110 can have the feature of the self-ligating bracket even when using the ligature technique.

### Sixth Modification

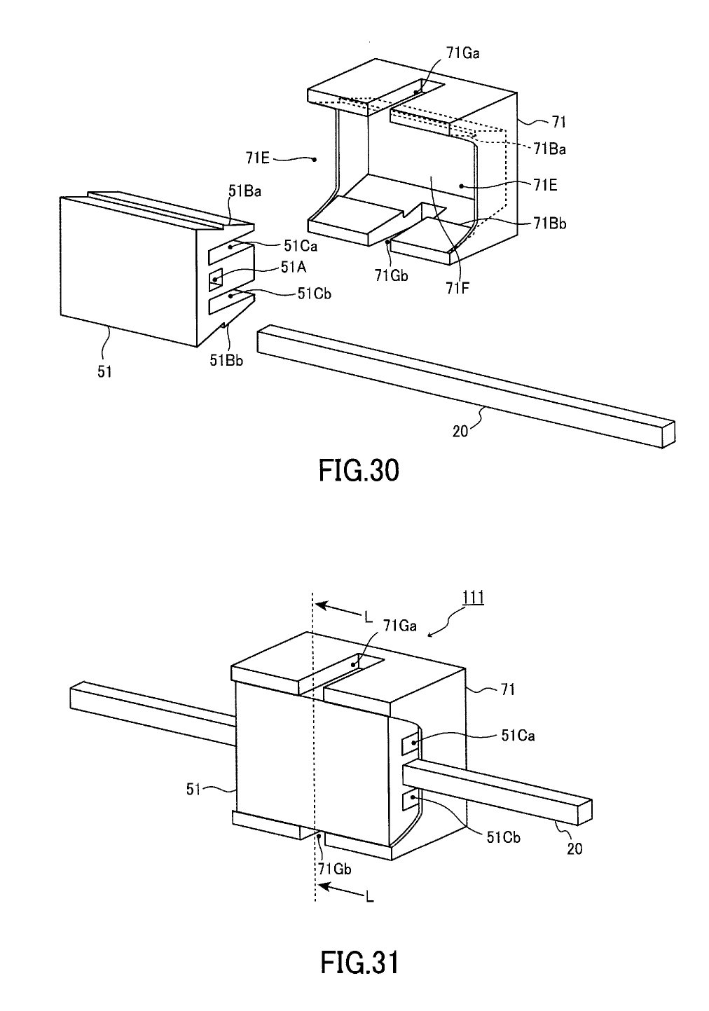

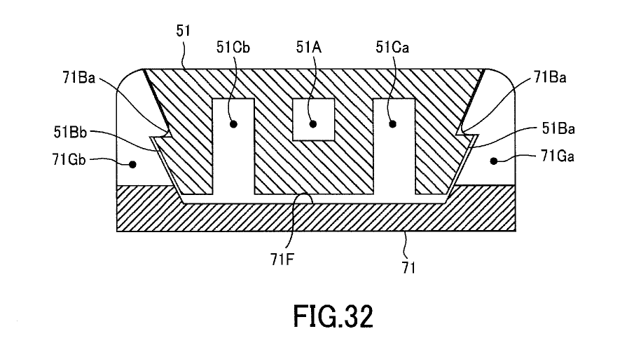

Next, an orthodontic bracket 111 according to a sixth modification of the present invention is described referring to FIG. 30, FIG. 31 and FIG. 32. FIG. 30 is a perspective view illustrating the outer appearance of a wire holder 51 and a bracket base 71 constituting the orthodontic bracket 111 according to the sixth modification. FIG. 31 is a perspective view illustrating the outer appearance of the orthodontic bracket 111. FIG. 32 is a cross-sectional view of the orthodontic bracket. 111 along a line L-L in FIG. 31. Note that, components that are the same as in the basic configuration illustrated in FIG. 1 to FIG. 14 are assigned the same names as in the basic configuration and a description of such components is omitted hereunder.

In the orthodontic bracket 111 of the sixth modification, mounting/detachment of the wire holder 51 with respect to the bracket base 71 is realized by deformation of the wire holder 51. This is the same as in the orthodontic bracket 101 of the first modification. The differences in the sixth modification relative to the first modification are the fixing structure for fixing the wire holder 51 in the bracket base 71, and the structure for mounting/detaching the wire holder 51 to/from the bracket base 71.

The orthodontic bracket 111 in the sixth modification has the wire holder 51 and the bracket base 71. The wire holder 51 is formed of, for example, plastic (synthetic resin) so as to elastically deform. On the other hand, because it is not necessary to cause the bracket base 71 to deform when detaching the wire holder 51, the bracket base 71 can be formed of, for example, ceramic.

The wire holder 51 is a block body whose surface shape is rectangular and whose cross-sectional shape (at a section orthogonal to the axial direction of a wire hole 51A) is trapezoidal. The bracket base 71 is a block body that has a rectangular parallelepiped shape. A concave-shaped holder slot 71F whose shape conforms to the shape of the wire holder 51 is formed in the surface of the bracket base 71. The top face and bottom face on the inner side of the holder slot 71F incline inwardly toward the bottom face side.

In order to fix the wire holder 51 in the bracket base 71, locking protrusions 51Ba and 51Bb are provided in the wire holder 51, and locking grooves 71Ba and 71Bb are provided in the bracket base 71. The locking protrusions 51Ba and 51Bb are provided along the entire top face and bottom face, respectively, of the wire holder 51 in the transverse direction. The locking protrusions 51Ba and 51Bb are linear protrusions that have a triangular cross-sectional shape, and incline toward the bottom face from a position that is at approximately the center with respect to the thickness of the wire holder 51. The locking grooves 71Ba and 71Bb are provided along the entire top face and bottom face, respectively, on the inner side of the holder slot 71F in the transverse direction. The locking grooves 71Ba and 71Bb are grooves having a cross-sectional shape that conforms to the cross-sectional shape of the locking protrusions 51Ba and 51Bb, and are provided from approximately the center position in the depth direction on the inner side of the holder slot 71F to the innermost portion thereof.

Further, slots 51Ca and 51Cb are provided in the wire holder 51 in order to cause the wire holder 51 to elastically deform when mounting the wire holder 51 in the holder slot 71F, and through grooves (pliers guide slots) 71Ga and 71Gb are provided in the bracket base 71 in order to detach the wire holder 51 that is fixed in the holder slot 71F from the holder slot 71F.

The slots 51Ca and 51Cb are vacant spaces of the same width that are cut into the wire holder 51 from the rear face (bottom face) of the wire holder 51 toward the surface, and are formed along the entire wire holder 51 in the transverse direction. The slot 51Ca is formed in parallel with the top face at approximately the center part between the wire hole 51A and the top face of the wire holder 51. The slot 51Cb is formed in parallel with the bottom face at approximately the center part between the wire hole 51A and the bottom face of the wire holder 51. Typically, the slots 51Ca and 51Cb are formed to have widths that are approximately equivalent to the width of the wire hole 51A, and are formed to a depth from the rear face of the wire holder 51 to a face on the surface side of the wire holder 51 that is on the inner side of the wire hole 51A. By forming the slots 51Ca and 51Cb in this way and forming the lateral width of a wire guide 71E on both side faces of the bracket base 71 to be somewhat narrower than the maximum width of the wire holder 51, as shown in FIG. 31 and FIG. 32, in a state in which the wire holder 51 is mounted in the bracket base 71, it is also possible for the slots 51Ca and 51Cb together with the bottom edge of the wire guide 71E to constitute other wire holes through which to insert the arch wire 20. Thus, since other wire holes that are different from the wire hole 51A are also provided, in a state in which the orthodontic bracket 111 is affixed to the surface of the teeth, the position at which the arch wire 20 is inserted through the orthodontic bracket 111 can be changed, and the direction and strength of an orthodontic force that is applied to the row of teeth can be easily changed.

The pliers guide slots 71Ga and 71Gb of the bracket base 71 are concave grooves that are provided at the center in the width direction of the surface of upper and lower side walls, respectively, and that penetrate through the upper and lower side walls in the vertical direction thereof. The depth of each of the grooves is equivalent to the thickness of the wire holder 51 or is somewhat less than the thickness of the wire holder 51.

By forming the slots 51Ca and 51Cb in the wire holder 51, the wire holder 51 can be mounted in the bracket base 71 by merely aligning the wire holder 51 with the holder slot 71F and pushing in the wire holder 51. At this time, as a result of the wire holder 51 being pressed against the inner surface of the holder slot 71F, the slots 51Ca and 51Cb are closed up and the wire holder 51 is deformed so as to curve in an arch shape by a small amount on the back face side. As a result, the width of the back face of the wire holder 51 narrows, and insertion and withdrawal of the wire holder 51 with respect to the holder slot 71F can be facilitated. The width of the wire holder 51 becomes smaller at the positions at which the slots 51Ca and 51Cb are formed. Consequently, it is possible for the wire holder 51 to be easily inserted into, or extracted out from, the holder slot 71F, while nonetheless firmly mounting the wire holder 51 to the bracket base 71. When the wire holder 51 reaches the innermost part of the holder slot 71F, by means of a restoring force that restores the wire holder 51 from a curved state to a steady state, the locking protrusions 51Ba and 51Bb of the wire holder 51 are automatically inserted into the locking grooves 71Ba and 71Bb provided in the holder slot 71F, and thus the wire holder 51 and the bracket base 71 are placed in a fixed state. It is possible for the dentist to confirm that the wire holder 51 is fixed in the bracket base 71 by means of a clicking sensation and sound that accompany the locking protrusions 51Ba and 51Bb being fitted into the locking grooves 71Ba and 71Bb.

When detaching the wire holder 51 from the bracket base 71, thin rods that are attached to the tip of a pliers clip are inserted through the pliers guide slots 71Ga and 71Gb to thereby press against the wire holder 51 from above and below, and the thickness of the wire holder 51 is caused to deform to become somewhat thinner by closing up the space in the incisions (slots) 51Ca and 51Cb. Thereby, the locking protrusions 51Ba and 51Bb are detached from the locking grooves 71Ba and 71Bb. In this state, the wire holder 51 can be drawn out in the forward direction from the holder slot 71F.

Note that, in the wire holder 51 illustrated in FIG. 30 and FIG. 32, although a configuration is illustrated in which two of the slots 51Ca and 51Cb are provided, as long as the wire holder 51 can deform when a force is applied in the vertical direction to the wire holder 51 it is also possible to provide one slot or three or more slots in the wire holder 51. Further, the amount of deformation of the wire holder 51 can be adjusted by changing the width of the slots (width of the surface opening portion), and the slots 51Ca and 51Cb may have a different width to the wire hole 51A, and may have different widths to each other. Further, although a configuration is adopted above in which each of the slots 51Ca and 51Cb has the same width across the entire area in the depth direction, the slots 51Ca and 51Cb may have a shape that expands in a tapered shape in the depth direction of the slot. Further, in accordance with the amount of deformation of the wire holder 51, it suffices that the depth of the slots 51Ca and 51Cb is at least more than ⅓ of the depth (thickness) of the wire holder 51, and the slots 51Ca and 51Cb need not be exposed at the top portion from the lower edge of the wire guide 71E. Furthermore, although the slots 51Ca and 51Cb are formed in a direction so as to be parallel with the top face of the wire holder 51, it is also possible to form at least one of the slots 51Ca and 51Cb in a slanting direction or an orthogonal direction relative to the top face of the wire holder 51.

Although in the foregoing configuration the locking protrusions 51Ba and 51Bb are provided along the entire wire holder 51 in the transverse direction, a configuration may also be adopted in which the locking protrusions 51Ba and 51Bb are provided only at a part of the wire holder 51 in the transverse direction. In conformity therewith, the locking grooves 71Ba and 71Bb are provided at one part in the transverse direction of the top face and the bottom face on the inner side of the holder slot 71F at positions that correspond to the locking protrusions 51Ba and 51Bb of the wire holder 51 mounted in the holder slot 71F.

Thus, by using the wire holder 51, the orthodontic bracket 111 of the sixth modification has similar operational advantages to the orthodontic bracket 100 having the basic configuration that is described above. Further, in the orthodontic bracket 111 of the sixth modification, by causing the wire holder 51 to deform, the wire holder 51 can be easily inserted into the bracket. base 71, and a load need not be applied to the bracket base 71. In addition, the wire holder 51 can be mounted to the bracket base 71 by merely pressing the wire holder 51 against the holder slot 71F. Thereby, even in a narrow working environment inside an oral cavity, work to mount the wire holder 51 in the bracket base 71 is easy, and the time taken to perform the procedure can be shortened. Further, because a fixing structure is used that fixes the wire holder 51 on the inner side of the holder slot 71F, and not a fixing structure in which the bracket base 61 is covered with the wire holder 41 as in the first modification, the bracket itself can be made a smaller size. In addition, in the orthodontic bracket 111 of the sixth modification, because the slots 51Ca and 51Cb are formed from the rear face in the direction toward the surface, the slots 51Ca and 51Cb cannot be seen from the front face. Therefore, there is no loss in the aesthetic characteristics.

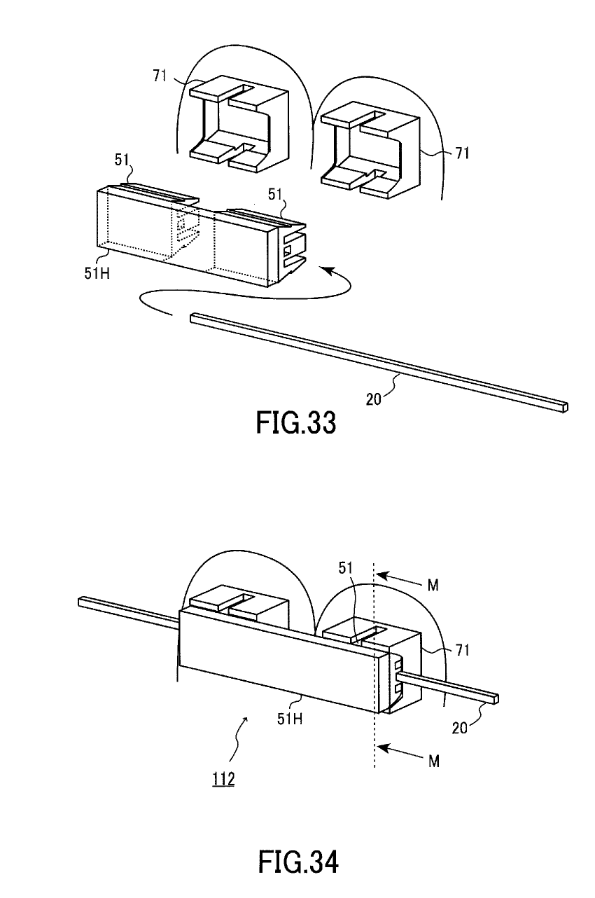

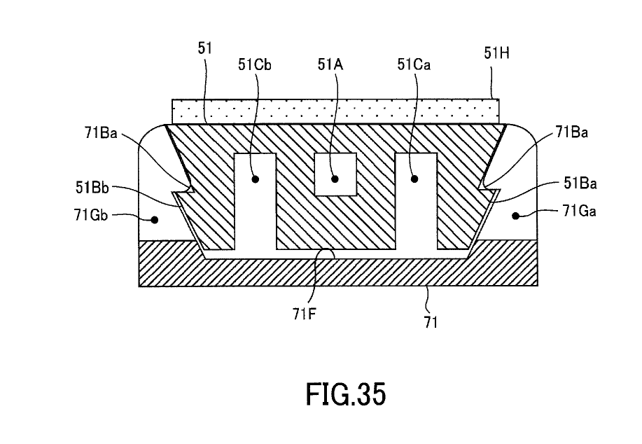

Note that, a plurality of the wire holders 51 may be linked together by an elastic body. For example, as shown in FIG. 33 and FIG. 34, one wire holder 51 and another wire holder 51 are coupled together by a rubber piece 51H. As shown in FIG. 35, one end of the rubber piece 51H is adhered by an adhesive to the surface of one of the wire holders 51, and the other end is adhered by an adhesive to the surface of the other wire holder 51. Further, one end of the rubber piece 51H may be adhered to a side face of one of the wire holders 51, and the other end may be adhered to a side face of the other wire holder 51. In addition, the rubber piece 51H may be integrally molded to the wire holders 51, and not adhered by an adhesive to the wire holders 51.

The length of the rubber piece 51H is adjusted according to, with respect to each of two teeth that are adjacent, whether an orthodontic force is to be applied in a direction to bring the teeth close to each other or an orthodontic force is to be applied in a direction to separate the teeth from each other. When using the rubber piece 51H whose length is shorter than the distance between two of the bracket bases 71 that are respectively mounted on two teeth, by mounting two of the wire holders 51 constituting a wire holder pair 112 to the two bracket bases 71, respectively, in a state in which the rubber piece 51H is expanded, an orthodontic force in a direction that brings the two adjacent teeth closer to each other can be applied to each tooth by means of the restoring force of the rubber piece 51H. Similarly, when using the rubber piece 51H whose length is longer than the distance between two of the bracket bases 71 that are respectively mounted on two teeth, by mounting two of the wire holders 51 constituting the wire holder pair 112 to the two bracket bases 71, respectively in a state in which the rubber piece 51H is contracted, an orthodontic force in a direction that separates the two adjacent teeth from each other can be applied to each tooth by means of the restoring force of the rubber piece 51H.

By using the wire holder pair 112 that are coupled by the rubber piece 51H for orthodontic treatment in this manner, in a case where the orthodontic force is insufficient when using only the arch wire 20, the restoring force of the rubber piece 51H can be used to compensate for the insufficient amount of orthodontic force of the arch wire 20, and thus the period of time required for the treatment can be shortened. Note that, another elastic body, for example, a coiled spring may be used instead of the rubber piece 51H. In the case of using a coiled spring instead of the rubber piece 51H, an orthodontic force can be applied according to the length of the coiled spring, specifically, in a case where the length of the coiled spring is shorter than the distance between the bracket bases 71 mounted on each of two adjacent teeth, an orthodontic force in a direction that brings the teeth close to each other can be applied to each of the two teeth. Similarly, in a case where the length of the coiled spring is longer than the distance between the bracket bases 71 mounted on each of two adjacent teeth, an orthodontic force in a direction separates the teeth from each other can be applied to each of the two teeth.

### Seventh Modification

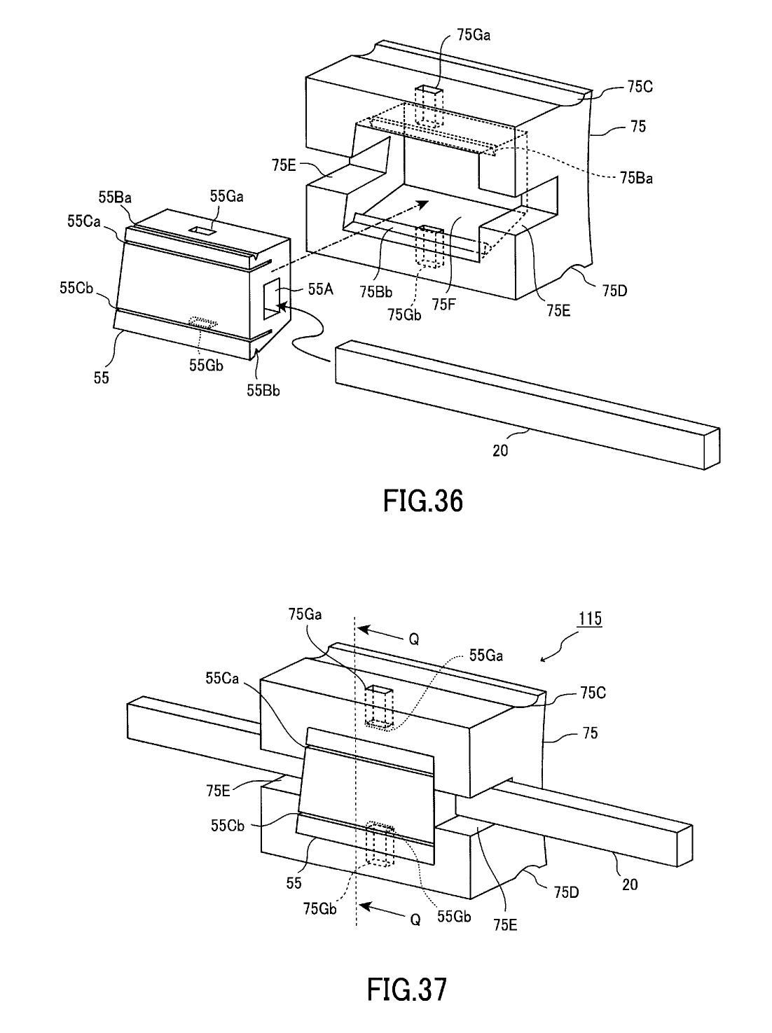

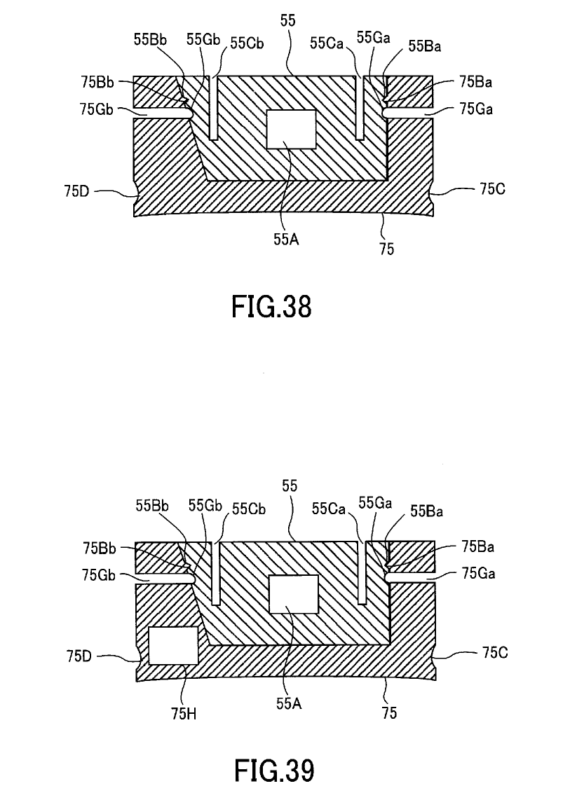

Next, an orthodontic bracket 115 according to a seventh modification of the present invention will be described referring to FIG. 36, FIG. 37, FIG. 38 and FIG. 39. FIG. 36 is a perspective view illustrating the outer appearance of a wire holder 55 and a bracket base 75 that constitute the orthodontic bracket 115 according to the seventh modification. FIG. 37 is a perspective view illustrating the outer appearance of the orthodontic bracket 115. FIG. 38 is a cross-sectional view of the orthodontic bracket 115 along a line P-P in FIG. 37. FIG. 39 is another cross-sectional view of the orthodontic bracket 115 along the line P-P in FIG. 37. Similarly to the orthodontic bracket 111 of the sixth modification, in the orthodontic bracket 115 of the seventh modification, mounting/detachment of the wire holder 55 with respect to the bracket base 75 is realized by deformation of the wire holder 55. In the orthodontic bracket 115 of the seventh modification is an orthodontic bracket in which the slots 51Ca and 51Cb which are provided in the rear face of the wire holder 51 of the orthodontic bracket 111 of the sixth modification are provided in the surface, and apart from the arrangement of the slots 51Ca and 51Cb the orthodontic bracket 115 of the seventh modification has basically the same structure as the structure of the orthodontic bracket 111 of the sixth modification.

A wire hole 55A and wire mounting slots (mounting grooves) 55Ba and 55Bb are provided in the wire holder 55. The configuration of these components is the same as in the wire holder 42 of the second modification. Further, in the wire holder 55, the slot 55Ca is formed in the surface at a position which is between the wire hole 55A and the top face of the wire holder 55 and which is near to the top face. Further, the slot 55Cb is formed in the surface at a position which is between the wire hole 55A and the bottom face of the wire holder 55 and which is near to the bottom face. The slots 55Ca and 55Cb are formed along the entire wire holder 55 in the transverse direction. The slots 55Ca and 55C are incisions (vacant spaces) from the surface of the wire holder 55 toward the inside (rear face) thereof that have a depth that is at least more than ½ of the depth (thickness) of the wire holder 55 and is less than ⅘ or ⅔ of the depth thereof, and for example, reach the depth at which the mounting slots 55Ba and 55Bb are provided, or reach an additionally deeper position. For example, the vacant space of each of the slots 55Ca and 55Cb is formed, for example, as shown in FIG. 36 and FIG. 37, in a direction so that the slots 55Ca and 55Cb are parallel with the top face of the wire holder 55.

In addition, receiving portions 55Ga and 55Gb for receiving the tip of a pliers clip are provided in the wire holder 55. As the pliers receiving portions 55Ga and 55Gb, a recession is formed in each of the top face and the bottom face of the wire holder 55. In a state in which the wire holder 55 is mounted in the bracket base 75, the pliers receiving portions 55Ga and 55Gb constitute pliers insertion holes that are continuous with the through-holes 75Ga and 75Gb of the bracket base 75, respectively.

When taking the wire holder 55 out from the bracket base 75, by inserting a dedicated extrusion tool into the pliers insertion hole and applying a force from the vertical direction to the wire holder 55, the wire holder 54 is caused to deform to become somewhat thinner so that the slots 55Ca and 55Cb are closed up. Thereby, the mounting slots 55Ba and 55Bb detach from the locking protrusions 75Ba and 75Bb. By drawing the wire holder 55 out from the holder slot 75F in this state, the fixed state formed by the locking protrusions 75Ba and 75Bb and the mounting slots 55Ba and 55Bb can be released.

The locking protrusion (linear protrusions) 75Ba and 75Bb, groove portions 75C and 75D, wire guides 75E, and the holder slot 75F are provided in the bracket base 75. The configuration of these components is the same as in the bracket base 62 of the second modification. Note that, the extension portions 62Ga and 62Gb provided in the orthodontic bracket 102 of the second modification are omitted from the orthodontic bracket 111 of the seventh modification.

Further, in the bracket base 75, a through-hole (pliers guide hole) 75Ga that penetrates the upper side wall thereof in the vertical direction is provided at the center in the width direction. Similarly, a through-hole 75Gb that penetrates the lower side wall of the bracket base 75 in the vertical direction is provided at the center in the width direction.

The positions at which the through-holes 75Ga and 75Gb are formed are, with respect to the depth direction, positions that are in the middle of an area from the surface of the bracket base 75 to the incision depth of the incisions (slots) 55Ca and 55Cb of the wire holder 55 in a state in which the wire holder 55 is mounted in the bracket base 75.

The wire holder 55 can be removed from the bracket base 75 by inserting thin rods that are attached to tip of a pliers clip through the through-holes 75Ga and 75Gb to thereby press against the wire holder 54 from above and below to cause the thickness of the wire holder 54 to deform to become somewhat thinner so as to close up the incisions (slots) 55Ca and 55Cb, thereby detaching the linear protrusions 75Ba and 75Bb from the wire mounting slots (mounting grooves) 55Ba and 55Bb and allowing the wire holder 55 to be drawn out in the frontward direction.

Thus, the orthodontic bracket 115 of the seventh modification has similar operational advantages to the orthodontic bracket 100 having the basic configuration that is described above. In addition, because the slots 55Ca and 55Cb are provided in the surface of the wire holder 55, confirmation by visual observation that the wire holder 55 is mounted in the bracket base 75 is facilitated.

Note that, as shown in FIG. 39, at least one wire hole 75H through which the arch wire 20 for orthodontic treatment can be inserted may be provided in the bracket base 75. The wire hole 75A may have the same cross-sectional shape and the same cross-sectional dimensions as the wire hole 55A of the wire holder 55, or at least one of the cross-sectional shape and cross-sectional dimensions of the wire hole 75A may be different from the wire hole 55A. By providing the wire hole 75H in the bracket. base 75 separately from the wire hole 55A of the wire holder 55 in this manner, for example, an orthodontic force or the like can be applied in a complex way in a plurality of directions using a plurality of arch wires to perform orthodontic treatment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### REFERENCE SIGNS LIST

100 . . . orthodontic bracket, 20 . . . arch wire, 40 . . . wire holder, 41A . . . wire hole, 60 . . . bracket base, 61F . . . holder slot.

1. An orthodontic bracket that is used for correcting dentition of a patient, comprising:
a wire holder having at least one through-hole through which an arch wire for orthodontic treatment is to be inserted; and
a bracket base which detachably supports the wire holder, and which is to be affixed to a surface of a tooth of the patient.;
wherein:
a holder slot into which the wire holder is to be fitted is provided in the bracket base, and
to cause the wire holder to curve and facilitate insertion and withdrawal of the wire holder with respect to the holder slot of the bracket base, at least one incision is formed in the wire holder in parallel with the through-hole from a rear face toward a surface of the wire holder.

2. The orthodontic bracket according to claim 1, wherein the wire holder is a truncated square pyramid shape.

3. The orthodontic bracket according to claim 2, wherein a transverse cross-sectional shape of the wire holder is a trapezoid shape.

4. The orthodontic bracket according to claim 1, wherein:
a holder slot into which the wire holder is to be fitted is provided in the bracket base; and
one of a linear protrusion and a groove portion is formed in a transverse direction in a side face of the wire holder, and the other of the linear protrusion and the groove portion is formed across the transverse direction in an inner surface of the holder slot of the bracket base, and the wire holder is coupled to the bracket base by the linear protrusion being fitted into the groove portion.

5. The orthodontic bracket according to claim 1, wherein:
a holder slot into which the wire holder is to be fitted is provided in the bracket base; and
a height of the wire holder is substantially equivalent to a depth of a holder housing portion of the holder slot of the bracket base.

6. The orthodontic bracket according to claim 1, wherein the wire holder is coupled to another wire holder by an elastic body.

7. The orthodontic bracket according to claim 6, wherein the elastic body is a rubber piece or a spring.

8. A bracket base that comprises an orthodontic bracket together with a wire holder having at least one through-hole through which an arch wire for orthodontic treatment is to be inserted, the bracket base comprising:
a holder slot having a truncated square pyramid shape into which the wire holder is to be fitted from a surface side;
wherein a rear face of the bracket base is to be affixed to a surface of a tooth of a patient.

9. An orthodontic bracket that is used for correcting dentition of a patient, comprising:
a wire holder having at least one through-hole through which an arch wire for orthodontic treatment is to be inserted; and
a bracket base having a holder slot into which the wire holder is to be fitted from a surface side, and in which a rear face of the bracket base is to be affixed to a surface of a tooth of the patient.
